(19) United States
(12) Patent Application Publication
(10) Pub. No.: US 2026/0072757 A1
(43) Pub. Date: Mar. 12, 2026

(54) SYSTEMS AND METHODS FOR UTILIZING ONBOARD VEHICLE HARDWARE FOR COMPUTE TASKS IN A CLOUD COMPUTING ENVIRONMENT

(71) Applicant: Adeia Guides Inc., San Jose, CA (US)

(72) Inventors: Charles Dasher, Lawrenceville, GA (US); Christopher Phillips, Hartwell, GA (US)

(21) Appl. No.: 18/882,564

(22) Filed: Sep. 11, 2024

(51) Int. Cl. G06F 9/50; H04L 67/101; H04L 67/1012; H04L 67/1021

(52) U.S. Cl. CPC G06F 9/5077; G06F 9/5044; G06F 9/5072; H04L 67/101; H04L 67/1012; H04L 67/1021

(57) ABSTRACT

Aspects of the present application leverage vehicle information status and historical information in conjunction with 6G network slice allocation to efficiently utilize unused processing capacity of vehicles for dynamically allocating compute tasks. A cloud service management server may determine multiple vehicles' compute availability taking into account vehicles' compute capacity, vehicles' location and location history, and schedules to predict and utilize vehicles' unused processing capacity. Historical information may be utilized by the cloud service management server to predict availability of the vehicle to increase confidence for the compute task. Implementing the cloud service management server with 6G network connectivity provides for a significant upgrade in network reliability having data speeds exceeding 1 Tbps and ultra-low latency of less than 1 microsecond.

### CROSS REFERENCE TO RELATED APPLICATIONS

This patent application is related to patent application titled “SYSTEMS AND METHODS FOR UTILIZING ONBOARD VEHICLE HARDWARE FOR SLAM TASKS IN A CLOUD COMPUTING ENVIRONMENT” attorney docket 003597-4060-101 filed on Sep. 11, 2024 which is herein incorporated by reference in its entirety.

### BACKGROUND

This disclosure is related to computing tasks in a cloud computing environment, and in particular, to utilizing onboard vehicle hardware to compute tasks within a cloud computing environment.

### SUMMARY

Modern vehicles include a sophisticated ensemble of hardware that has significant processing capacity. This processing capacity is used mainly by the vehicle for driving-related tasks, which may include advanced driver-assistance systems (ADAS) that infer safety hazards and automatically prevent or mitigate the detected risk. In other applications, the vehicle's processing capacity may be used for autonomous driving activities. However, when the vehicle is idle or parked, the vehicle's processing capacity is unused. There is an opportunity to utilize a vehicle's unused processing capacity for compute tasks that require a significant level of processing.

Even though there is compute availability from modern vehicles with processing capacity, it is problematic to determine when a vehicle would be available to be utilized for a specific compute task. In one approach, a cloud computing system may individually query each vehicle to check if that vehicle is currently idle and available for a compute task. If the vehicle is available for a compute task, a task is assigned to that vehicle based on a response. However, such an approach provides no assurance that the vehicle may remain available for the duration of the task. For example, a vehicle that is currently available for compute may start driving and become unavailable 30 minutes into an hour long test, leading to the task failing. The lack of assurance prevents an efficient and dependable utilization of the processing capacity of the vehicle. In such an approach, the cloud computing system is unable to predict when vehicle compute will become available and stay available in the future leading to continuing failure to leverage the vehicle's unused processing capacity.

To solve these problems, systems and methods are provided herein for leveraging vehicle information status and historical information in conjunction with 6G network slice allocation to efficiently utilize unused processing capacity of vehicles for dynamically allocating compute tasks. In some embodiments, a cloud service management server determines multiple vehicles' compute availability taking into account the vehicles' compute capacity (including the ability to run a virtual image and the compute task on the vehicle), the vehicles' location and location history, and schedules to predict and utilize the vehicles' unused processing capacity. Historical information may be utilized by the cloud service management server to predict availability of the vehicle to increase confidence for the compute task. Implementing the cloud service management server with 6G network connectivity provides for a significant upgrade in network reliability having data speeds exceeding 1 Tbps and ultra-low latency of less than 1 microsecond.

In some embodiments, the cloud service management server may receive a request for a compute task (e.g., hosting a gaming server) from a task device (e.g., a gaming computer). The request may have a hardware requirement, schedule, and location. For example, the request may require a minimum processing capacity of an Intel i7 processor, to be hosted at on July 31 between 9 PM and 9 AM and hosted within a 3 mile radius of San Francisco, California to ensure there is low latency for local players.

In some embodiments, the cloud service management server may access, for a set of vehicles, location, hardware, location history, and history of hardware availability. For example, some vehicles may be charging overnight in San Francisco at an overnight charging station, and historical data for these vehicles show that once the vehicles are parked and charging, they are not typically used during the night with a 98% confidence value. There is then a determination made, based on the accessing, whether a compute set of the vehicles (e.g., a subset of vehicles) is available to perform the compute task. Continuing from the example above, it is determined that two of the vehicles at the overnight charging station have Intel i9 processors (greater than Intel i7) with 6G connectivity and can host the gaming server. If there is a compute set found, the cloud service management server may provide the computing data to the compute set to perform the compute task, and transmit an output from the compute set to the task device. Continuing from the example above, the two vehicles are given the parameters to create the gaming server, and host the gaming server. This information is then relayed from the vehicles, through the cloud service management server, to the gaming computer.

In some embodiments, the cloud service management server may determine availability confidence values for each vehicle indicating the likelihood of the respective vehicle's availability. For example, a first vehicle may have an Intel i9 processor and meet the hardware requirements; however, based on historical information, the vehicle may not be available for the full duration of the desired gaming server compute task. As such, the confidence value for the first vehicle may be lower, based on the totality of information for the first vehicle. The cloud service management server may then identify the compute set (e.g., the subset) based on the determined respective availability confidence value of each of the vehicles. Continuing from the example above, the first vehicle may not form part of the compute set given that the confidence value is not high enough to meet the confidence standard for the compute set. In some variants, the cloud service management server may use an aggregate availability confidence value based on each of the respective availability confidence values. In this variant, the first vehicle may be included in the compute set if there are other vehicles with higher confidence values such that the aggregate availability confidence value meets the confidence standard for the compute set.

In some embodiments, the compute task is performed using a network operating on a 6G protocol. This may include the cloud service management server allocating a 6G network slice for the computing set and/or suballocating portions of the 6G network slice for each respective vehicle in the compute set. Some configurations provide for two vehicles to be connected via a physical bus to amalgamate hardware components of both vehicles into a singular hardware resource. For example, if two vehicles are using a charging station, a physical connection that connects both vehicles to the charging station may also provide for a bus connection allowing for amalgamation of the individual vehicle hardware components. This allows for the compute task to utilize the amalgamated hardware resource performing the compute at a higher performance than it would without the physical bus.

In some embodiments, the cloud service management server may generate a user interface (e.g., at a vehicle charging station) allowing for selection of vehicle charging options. For example, selections are presented for charging the vehicle the fastest without performing the compute task. Another selection may be made that charges the vehicle at a moderate rate while also performing the compute task. In some variants, selections may be made to schedule charging and compute tasks via the user interface.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1A shows an illustrative scenario where a cloud service management server receives a request to host a gaming server, in accordance with some embodiments of this disclosure.

FIG. 1B shows an illustrative scenario where a cloud service management server determines, based on the accessing, whether a computing set is available to perform the compute task, in accordance with some embodiments of this disclosure.

FIG. 1C shows an illustrative scenario where a cloud service management server provides computing data to perform the computing task via the computing set, in accordance with some embodiments of this disclosure.

FIG. 2 shows an illustrative scenario where two vehicles are connected via physical computing bus at a vehicle charging station, in accordance with some embodiments of this disclosure.

FIG. 3 shows an illustrative scenario of a vehicle charger dashboard, in accordance with some embodiments of this disclosure.

FIG. 4 shows an illustrative scenario of a 6G Network Slice definition, in accordance with some embodiments of this disclosure.

FIG. 5 shows an illustrative scenario of a system diagram of cloud service management server configured a compute task from one or more vehicles, in accordance with some embodiments of this disclosure.

FIG. 6 shows an illustrative scenario of a system diagram of cloud service management server with 6G Network Slice definition, in accordance with some embodiments of this disclosure.

FIG. 7 shows an illustrative scenario of a modular system diagram, in accordance with some embodiments of this disclosure.

FIG. 8 shows an illustrative scenario of a flow diagram for information passing from the vehicle sensors to the cloud service management system, in accordance with some embodiments of this disclosure.

FIG. 9 shows an illustrative scenario of a flow diagram including historical data storage of vehicles, in accordance with some embodiments of this disclosure.

FIG. 10 shows an illustrative scenario of a flow diagram including a user interface of a vehicle, in accordance with some embodiments of this disclosure.

FIG. 11 shows an illustrative scenario of a flow diagram including a user interface providing options for opting in or out of a cloud service for a vehicle, in accordance with some embodiments of this disclosure.

FIG. 12 shows an illustrative scenario of a flow diagram for a cloud task scheduler, in accordance with some embodiments of this disclosure.

FIG. 13 shows an illustrative scenario of a flow diagram including a user interface receiving a request for vehicle performance data, in accordance with some embodiments of this disclosure.

FIG. 14 shows an illustrative scenario of a flow diagram including a user interface that provides compensation details in relation to staking, in accordance with some embodiments of this disclosure.

FIG. 15 shows an illustrative scenario of a flow diagram for a distributed computing task, in accordance with some embodiments of this disclosure.

FIG. 16 shows an illustrative scenario of a flow diagram for vehicle GPS system transmitting vehicle location data, in accordance with some embodiments of this disclosure.

FIG. 17 shows illustrative user equipment devices, in accordance with some embodiments of this disclosure.

FIG. 18 shows illustrative systems, in accordance with some embodiments of this disclosure.

FIG. 19 is a flowchart of a detailed illustrative process for determining whether a computing set of a plurality of vehicles is available to perform a compute task, in accordance with some embodiments of this disclosure.

FIG. 20 is a flowchart of a detailed illustrative process for determining a respective availability confidence value indicative of a probability that the respective vehicle will be available to perform the compute task, in accordance with some embodiments of this disclosure.

FIG. 21 is a flowchart of a detailed illustrative process for generating for display a user interface for a vehicle charging station, in accordance with some embodiments of this disclosure.

### DETAILED DESCRIPTION

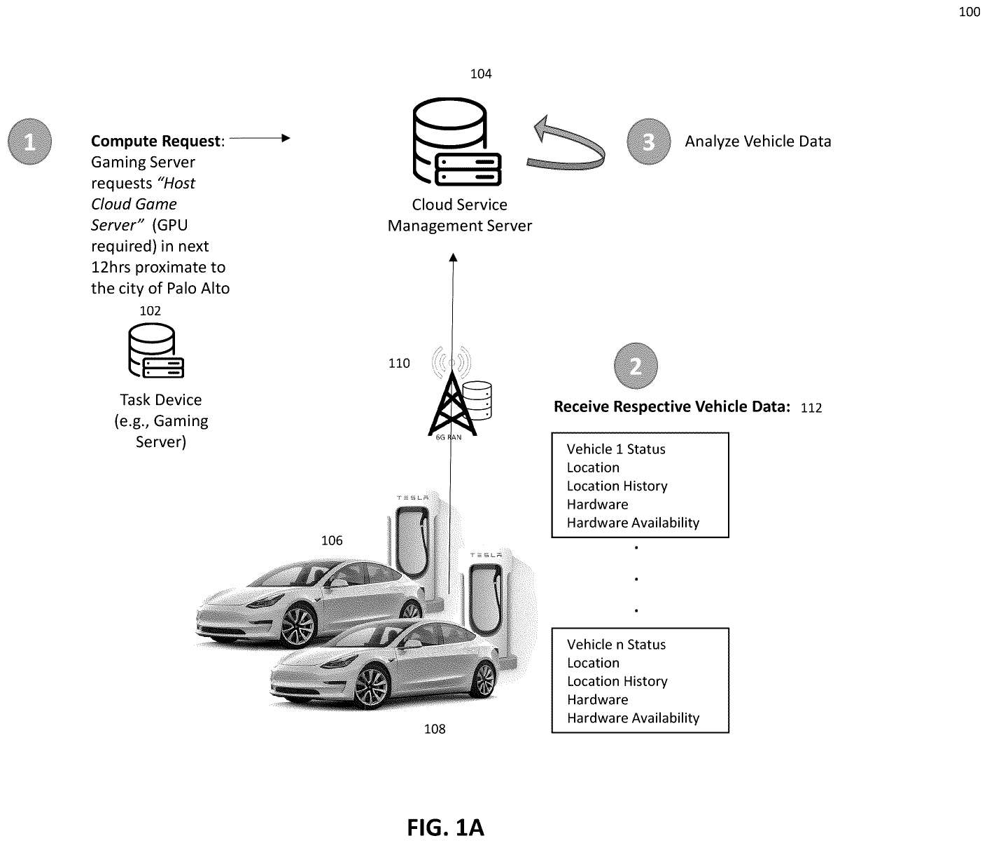

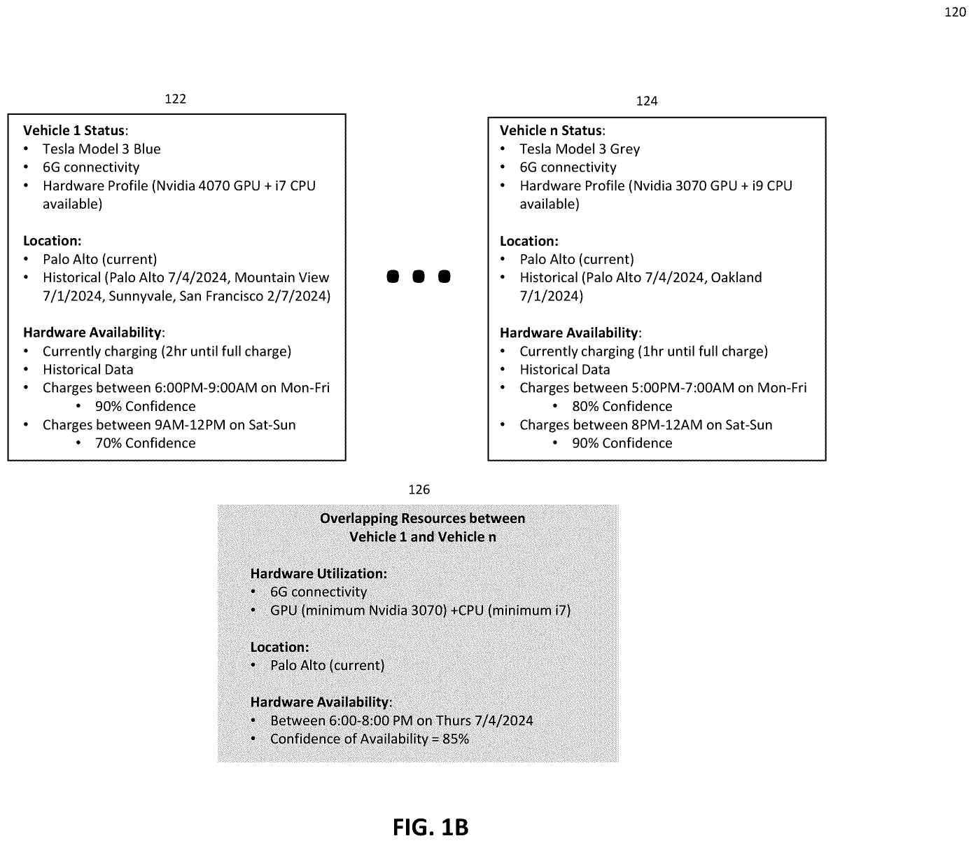

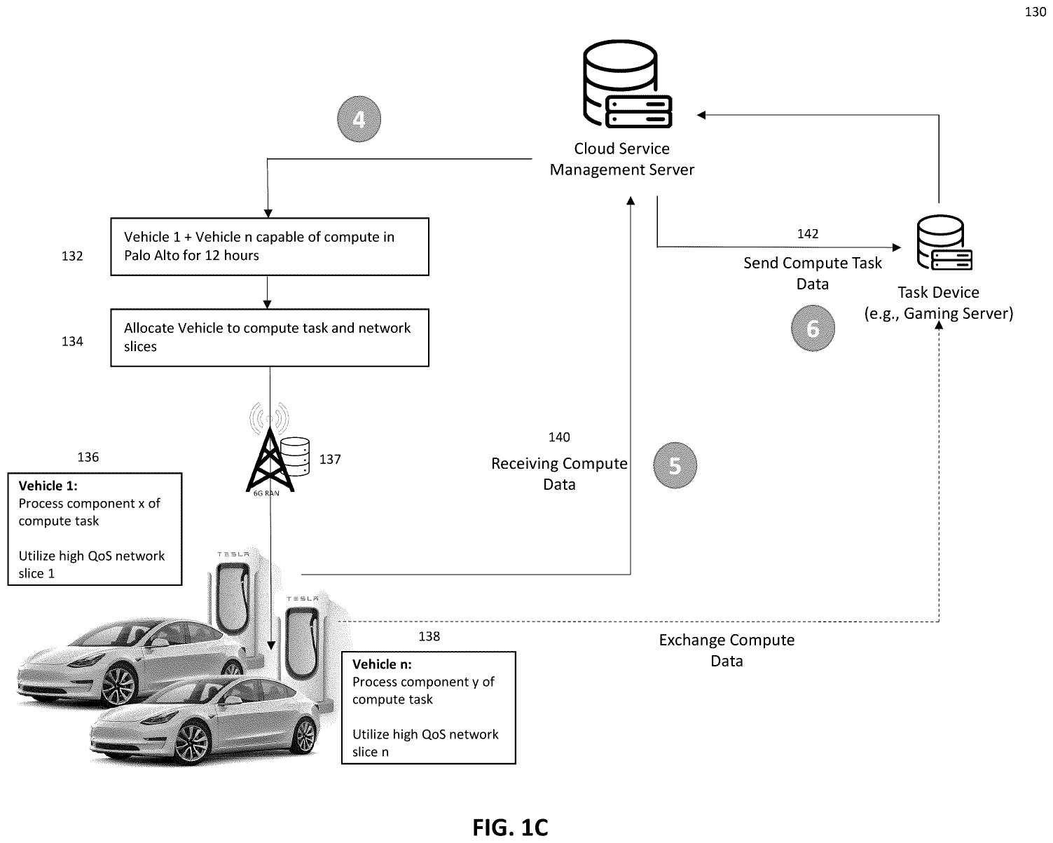

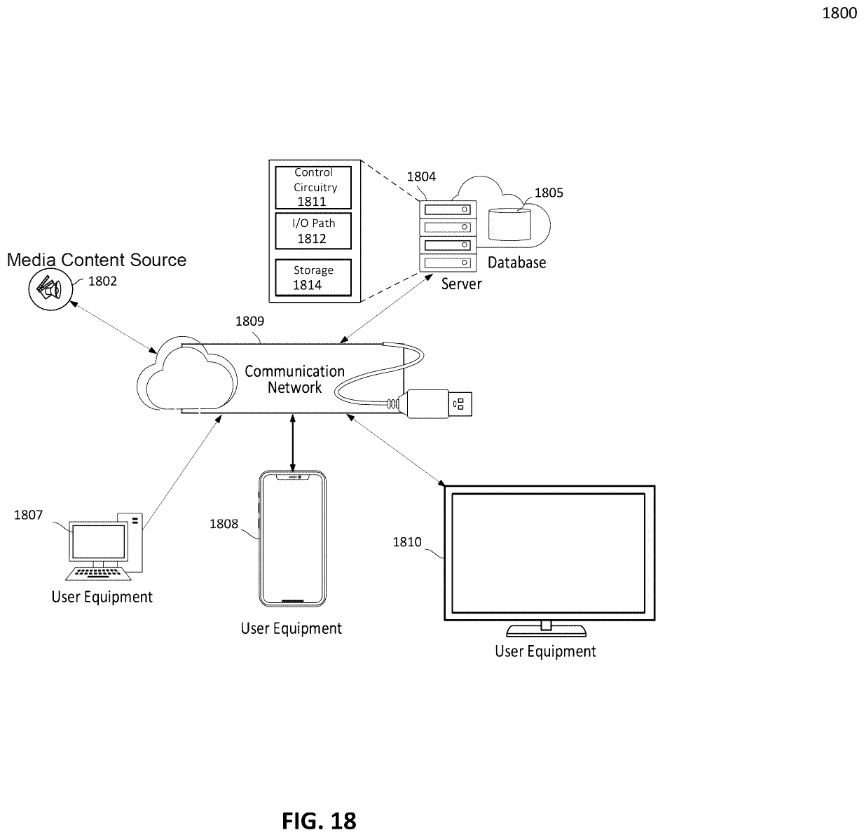

FIG. 1A shows an illustrative scenario 100 where a cloud service management server receives a request to host a gaming server, in accordance with some embodiments of this disclosure. In some embodiments, a cloud service management server is implemented to efficiently utilize unused processing capacity of vehicles for dynamically allocating compute tasks. In some embodiments, the cloud service management server may implement a software media application to perform the functionality of the cloud service management server. In some embodiments, the media application may run on a cloud service management server, the user equipment, or a combination of the two. In some embodiments, the cloud service management server may be server 1804 in FIG. 18.

In some embodiments, the cloud service management server may receive a request for a compute task from a task device. A task device may be any device that requires compute to be performed. In some variants, the task device may be a personal computer, a smart appliance, a media server, a mobile phone, a tablet, an internet-of-things device, or any device having network connectivity and processing capacity. In some embodiments, the task device may be user equipment 1807, 1808, or 1810 in FIG. 18. For example, as shown in FIG. 1A, the task device may be a gaming server 102 that has an Intel i5 processor and Wi-Fi internet connectivity. The received request by the cloud service management server 104 may specify a hardware requirement for the compute task, a schedule for the compute task, and a location constraint. A hardware requirement may be any type of hardware specification for any type of hardware component. For example, the hardware requirement may include a requirement for a particular type of central processing unit, a requirement for a particular type of graphical processing unit, a requirement for a particular type of an artificial-intelligence chipset, a requirement for a particular type of dedicated chipset for a defined task function, a requirement for a particular type of memory, a requirement for a particular type of cache, a requirement for a particular type of storage, or a requirement for a particular type of processing chips. The schedule for the compute task may be any temporal parameter in relation to the requested compute task having any type of temporal granularity. The location constraint may be any locational parameter in relation to the requested compute task having any type of locational granularity. Continuing from the earlier example, the request may specify that the gaming server must have a dedicated GPU, hosted for the next 12 hours from the time of the request, and be proximate to the city of Palo Alto (e.g., within a three-mile radius of the Palo Alto city limits).

In some embodiments, the cloud service management server may request further specifies a software requirement. For example, the request may be for a particular operating system, or virtual machine implementation. The virtual machine implementation may contain a virtualized operating system and one or more compute tasks to be executed on the operating system running on the virtual machine. In some embodiments, the cloud service management server may determine whether the at least the computing set of the plurality of vehicles is available to perform the compute task comprises determining whether the computing set of the plurality of vehicles comprises at least one vehicle with installed software that complies with the software requirement. Returning to FIG. 1 at 112, the cloud service management server may request further specifications and retrieve a software requirement (e.g., vehicle must be running Tesla proprietary operating system) from vehicle 1 and vehicle n. The cloud service management server retrieves information that both vehicle 1 and vehicle n are running Telsa's proprietary operating system.

In some embodiments, the cloud service management server may access, for each respective vehicle of a plurality of vehicles, a respective vehicle current location, a respective hardware for the compute task of the respective vehicle, a respective location history of the respective vehicle, and a respective history of availability of hardware for compute tasks of the respective vehicle. A current location may be any data that describes location such as GPS coordinates, city or town name, street address, postal code, location data via triangulation of sensors, or any other type of locational data. Respective hardware for the compute task may be accessed by the cloud service management server via system information of the vehicle through a communications interface. Respective hardware may also be determined based on the vehicle specification via a database comprising corresponding respective hardware profiles for respective vehicles. The respective location history of the respective vehicle may be accessed by the cloud service management server via system information of the vehicle through a communications interface. The respective location history may also be accessed via a vehicle database that stores all vehicle related information including respective location history. Respective history of availability may be accessed by the cloud service management server via system information of the vehicle through a communications interface. Respective history of availability may also be determined based on a vehicle database that stores all vehicle related information including history of availability. In some embodiments, the vehicles may be user equipment 1807, 1808, or 1810. Continuing with the above example from FIG. 1A, the cloud service management server 104 accesses respective vehicle data 112, via a 6G network protocol 110, from vehicles 106 and 108. The vehicle data is shown to include a respective vehicle current location, a respective hardware for the compute task of the respective vehicle, a respective location history of the respective vehicle, and a respective history of availability of hardware for compute tasks of the respective vehicle. In some embodiments, the respective history of availability may be accessed by the cloud service management server via a database (e.g., 1805 in FIG. 18). For example, the table below illustrates a data structure including history of availability data for one or more vehicles:

TABLE
History of Availability Data for Vehicle n

| Date/Time | Location(s) | Status |
|---|---|---|
| Aug. 8, 2024 | 1799-1705 Fulton St, Palo Alto, | Charging |
| 11:00 p.m.-7:00 a.m. | CA 94303 | |
| Aug. 9, 2024 | 150 University Ave, Palo Alto, CA | Parked (not |
| 7:00 a.m.-9:00 p.m. | 94301 | charging) |
| Aug. 8, 2024 | 1799-1705 Fulton St, Palo Alto, | Charging |
| 9:00 p.m.-6:55 a.m. | CA 94303 | |
| Aug. 8, 2024 | 150 University Ave Palo Alto, CA | Parked (not |
| 6:55 a.m.-5:00 p.m. | 94301 | charging) |
| Aug. 10, 2024 | The Embarcadero, San Francisco, | Charging |
| 5:00 p.m.-9:00 p.m. | CA, 94113 | |

In some embodiments, the cloud service management server may determine at the cloud service management server, based on the accessing, whether at least a computing set of the plurality of vehicles is available to perform the compute task. This determination is based on the provision of sufficient amount of compute capability to meet the hardware requirement for the compute task within a time period that complies with the schedule for the compute task at locations that meet the location constraint. FIG. 1B shows an illustrative scenario 120 where a cloud service management server determines, based on the accessing, whether a computing set is available to perform the compute task, in accordance with some embodiments of this disclosure. The data is reproduced as an embedded table below for convenience.

122
Vehicle 1 Status:
Tesla Model 3 Blue
6G connectivity
Hardware Profile (Nvidia 4070 GPU + i7 CPU available)
Location:
Palo Alto (current)
Historical (Palo Alto Jul. 4, 2024, Mountain
View Jul. 1, 2024, Sunnyvale, San Francisco Feb. 7, 2024)
Hardware Availability:
Currently charging (2 hr until full charge)
Historical Data
Charges between 6:00PM-9:00AM on Mon-Fri
90% Confidence
Charges between 9AM-12PM on Sat-Sun
70% Confidence
124
Vehicle n Status:
Tesla Model 3 Grey
6G connectivity
Hardware Profile (Nvidia 3070 GPU + i9 CPU available)
Location:
Palo Alto (current)
Historical (Palo Alto Jul. 4, 2024, Oakland Jul. 1, 2024)
Hardware Availability:
Currently charging (1 hr until full charge)
Historical Data
Charges between 5:00PM-7:00AM on Mon-Fri
80% Confidence
Charges between 8PM-12AM on Sat-Sun
90% Confidence
126
Overlapping Resources between Vehicle 1 and Vehicle n
Hardware Utilization:
6G connectivity
GPU (minimum Nvidia 3070) + CPU (minimum i7)
Location:
Palo Alto (current)
Hardware Availability:
Between 6:00-8:00 PM on Thurs Jul. 4, 2024
Confidence of Availability = 85%

The cloud service management server receives two sets of accessed data from the respective vehicles, vehicle 1 data 122, and vehicle n data 124. The cloud service management server determines whether each respective vehicle meets various criteria: namely sufficient amount of compute capability to meet the requirement for the compute task within a time period that complies with the schedule for the compute task at locations that meet the location constraint. In this example, the requirement from the gaming server requires that there be a dedicated GPU regarding the compute capability. Vehicle 1 includes a Nvidia 4070 GPU and vehicle n includes a Nvidia 3070 GPU; thus, both vehicles having GPUs satisfy the compute capability. The determination by the cloud service management server may be seen in 126 showing the minimum capability of both vehicle 1 and vehicle n. Both vehicle 1 and vehicle n are located within Palo Alto city limits, and both vehicles have availability greater than 12 hrs between 6:00 PM-7:00 AM. Thus, in this example, the determination is made by the cloud service management server that the computing set of vehicles (e.g., vehicle 1 and vehicle n) is available to perform the compute task.

In some embodiments, when determining whether the computing set of the plurality of vehicles is available to perform the compute task, the cloud service management server may, for each respective vehicle of the plurality of vehicles, determine a respective availability confidence value indicative of a probability that the respective vehicle will be available to perform the compute task during the time period that complies with the schedule for the compute task at locations that meet the location constraint. For example, this determination of a respective availability confidence value may be performed at 132 in FIG. 1C. Looking at FIG. 1B, vehicle 1 charges between 6:00 PM and 9:00 AM from Monday to Friday based on respective history of availability of hardware for compute tasks. There are instances where vehicle 1 is not available during these times. Based on probability determinations of the likelihood of availability based on the respective history of availability of hardware for compute tasks, the cloud service management server determines that the respective availability confidence value is 90%. In similar fashion, on weekends of Saturday and Sunday, vehicle 1 typically charges between 9:00 AM and 12:00 PM, but the respective availability confidence value is 70%. In another example, vehicle n typically charges between Monday to Friday between 5:00 PM and 7:00 AM, but the respective availability confidence value is 80%. On weekends of Saturday and Sunday, vehicle n typically charges between 8:00 PM to 12:00 AM, and the respective availability confidence value is 90%. The cloud service management server may then identify the computing set based on the respective availability confidence value of each vehicle of the plurality of vehicles and the respective availability of hardware of each vehicle of the plurality of vehicles. Continuing with the example, if the confidence value for vehicle n is 80% between Monday to Friday of times between 5:00 PM and 7:00 AM, the cloud service management server may identify vehicle n as part of the compute set. In contrast, vehicle 1 has a confidence value of 70% between the availability times of 9:00 AM-12:00 PM on Saturday and Sunday and this may not be identified as part of the compute set.

In some embodiments, an aggregate availability confidence value may be calculated by the cloud service management server based on each of the respective availability confidence values for each respective vehicle of the plurality of vehicles. For example, this determination of an aggregate availability confidence value may be performed at 132 in FIG. 1C. Continuing from the example from FIG. 1B, if each of the respective confidence values were 90%, 70%, 80%, and 90%, then the aggregate availability confidence value may be 82.5% if an average weighting is applied. In some embodiments, a mathematical model may be applied to weight the respective confidence values based on preset weights or biases. In some embodiments, the preset weights may be based on specific vehicles or specific time periods. The cloud service management server may further determine whether the aggregate availability confidence value exceeds a confidence threshold. The confidence threshold may be generated by the cloud service management server. In some embodiments, the confidence threshold may be input via a user interface at a charging station (e.g., selecting that the threshold must be 80% or better) or other device configured to modify the requested compute task. In some embodiments, the cloud service management server may generate a confidence threshold based on internal or external databases (e.g., databases having historical information of other previously generated confidence thresholds). In some embodiments, the cloud service management server may determine the computing set of the plurality of vehicles is available to perform the compute task based on the determination that the aggregate availability confidence value exceeds the confidence threshold. Continuing from the example above, if the confidence threshold is set to 80%, and the aggregate availability confidence value is 82.5%, then vehicle 1 and vehicle n would be determined to be the computing set to perform the compute task. If vehicle 1 leaves the charging station or home and is no longer available to perform the compute task, the aggregate availability confidence value decreases.

In some embodiments, in response to a determination that the computing set of vehicles is available to perform the compute task, the cloud service management server may provide computing data required for the compute task to the computing set of vehicles. The provision of computing data may cause the computing set of vehicles to perform the compute task within the time period that complies with the schedule for the compute task at locations that meet the location constraint and transmit a computing output from the computing set of vehicles. Continuing from the example above, FIG. 1C shows an illustrative scenario 130 where a cloud service management server provides computing data to perform the computing task via the computing set, in accordance with some embodiments of this disclosure. The cloud service management server, in response to determining vehicle 1 and vehicle n are the computing set of vehicles available to perform the compute task 132, allocates these vehicles 134 to the compute task via the network operating on a 6G protocol. In some embodiments, the cloud service management server also allocates one or more network slices to the vehicles 134. The provision of computing data at 136 is provided to vehicle 1 to process component x of the compute task and utilize the high quality of service network slice 1. In similar fashion, the cloud service management server provides computing data to vehicle n to process component y of the compute task and utilize the high quality of service network slice n. The cloud service management server, at 140, receives compute data from vehicle 1 and vehicle n, and sends the compute task data 142 to the task server.

In some embodiments, compute task is performed using a network operating on a 6G protocol. The cloud service management server may determine a network classification of the compute task based on an assigned classification. In some embodiments, the network operating on a 6G protocol may be implemented within the communication network 1809 in FIG. 18. For example, if the compute task is to host a gaming server, this may be classified as a high quality of service task within an assigned classification database. The cloud service management server may retrieve this network classification of “high quality of service” in relation to the specific compute task of hosting a gaming server as a consequence of retrieving this information from the assigned classification database. In some embodiments, the assigned classification may be multiple types of classifications for a compute task. In some embodiments, the assigned classification may be a designation of specific network resources, network configuration, and/or network optimization for a particular compute task. In some embodiments, the assigned classification may include assigning specific network slices for the compute task or for specific sub-tasks of the compute task. The cloud service management server may allocate at least one network slice for the computing set of the plurality of vehicles from a plurality of network slices in a common network. The specific allocated network slice is optimized for the network classification. For example, the allocated network slice for game hosting may be a network slice with ultra-low latency for high quality of service for the specific sub-task of transferring dynamic game data between the host server and a client device (e.g., the gaming player's hardware platform). In some embodiments, the cloud service management server may suballocate a portion of the at least one allocated network slice for each respective vehicle of the computing set. In some embodiments, the suballocation of the network slice may be provided at 134 of FIG. 1. The suballocation provides for an exclusive network resource for each respective vehicle of the computing set of the plurality of vehicles. For example, a network slice may be suballocated into two allocations with the first allocation for vehicle 1, and the second allocation for vehicle n. With the bandwidth increase in the 6G base station to 1 Tbps for both uplink and downlink along with a latency of less than 1 μs, leveraging compute at the base station will provide an extreme advantage for high bandwidth and ultra-low latency use cases. Electric vehicle (EV) charging stations are strategically placed along major highways, in urban centers, and at convenient locations like shopping centers, enabling EV owners to quickly recharge their vehicles while on long trips or during daily activities. In addition to their primary function of charging EVs, there is potential for charging stations to support high-speed internet connectivity. These charging stations could potentially be equipped with Wi-Fi capabilities or other forms of internet connectivity in the future (e.g., 6G network protocol). The use of 6G network protocols may provide for several advantages including the enablement of sub-6 GHz frequency bands, millimeter waves for mobile communication investigation of THz bands, non-RF bands, etc. The architecture of 5G uses mm Wave tiny cells with a range of roughly 100 meters and dense sub-6 GHz smaller base stations with umbrella macro base stations. In contrast, 6G design comprises cell-free smart surfaces operating at higher frequencies, transient hotspots generated by base stations placed on drones, and tests with miniature THz cells. Optimally for the presentation application, the reliability of a 6G network has a rating of 10-9, as opposed to 5G having a rating of 10-5.

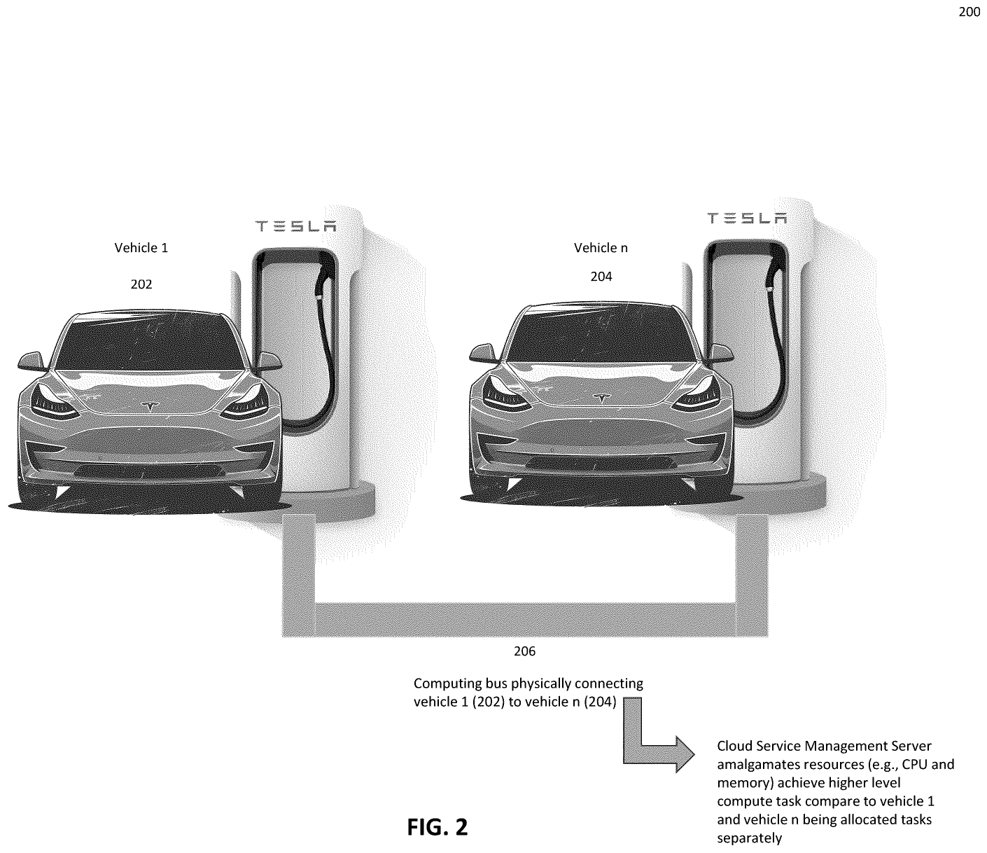

In some embodiments, a cloud service management server may connect at least two vehicles via a physical bus such that respective hardware components of each of the at least two vehicles are amalgamated into a singular hardware resource. This singular hardware resource may perform the compute task at a higher performance than the at least two vehicles without the physical bus. FIG. 2 shows an illustrative scenario 200 where two vehicles are connected via physical computing bus at a vehicle charging station, in accordance with some embodiments of this disclosure. Vehicle 1 (202) is connected to vehicle n (204) at a charging station that implements the physical bus connection 206. The cloud service management server may determine whether the computing set of the plurality of vehicles is available to perform the compute by accessing data for availability of the singular hardware resource that performs the compute task at the higher performance than the at least two vehicles without the physical bus. For example, this determination of a respective availability confidence value may be performed at 132 in FIG. 1C. In a scenario, vehicle 1 has an intel i7 CPU and vehicle n has an i9 CPU. As a singular hardware resource vehicle 1 and vehicle n have the combined CPU capability of the intel i7 and the intel i9. In some embodiments, the cloud service management server may determine a bus confidence value such that the at least two vehicles will be connected via the physical bus. This determination may be based on the accessing of the respective location histories of the at least two vehicles of the plurality of vehicles connected via the physical bus. For example, this determination of the bus confidence value may be performed at 132 in FIG. 1C. For example, if vehicle 1 and vehicle n are driven by work colleagues and they typically use the same charging station and parking position within the company parking lot on similar days, there is history of similar charging patterns at the same location and time. The cloud service management server may determine a bus confidence value that they will be connected via physical bus, which during 9:00 AM-5:00 PM from Monday to Friday may be 95%. The cloud service management server may then determine whether the bus confidence value exceeds a bus confidence threshold. Similar to the confidence threshold, the bus confidence threshold may be configured in similar fashion in relation to historical information related to charging in relation to physical bus connections. The cloud service management server may determine the computing set of the plurality of vehicles is available to perform the compute task based on the determination that the bus confidence value exceeds the bus confidence threshold. Continuing with the example above, if the bus confidence value is 95% and the bus threshold is 90%, then the computing set of vehicle 1 and vehicle n will be able to perform the compute task.

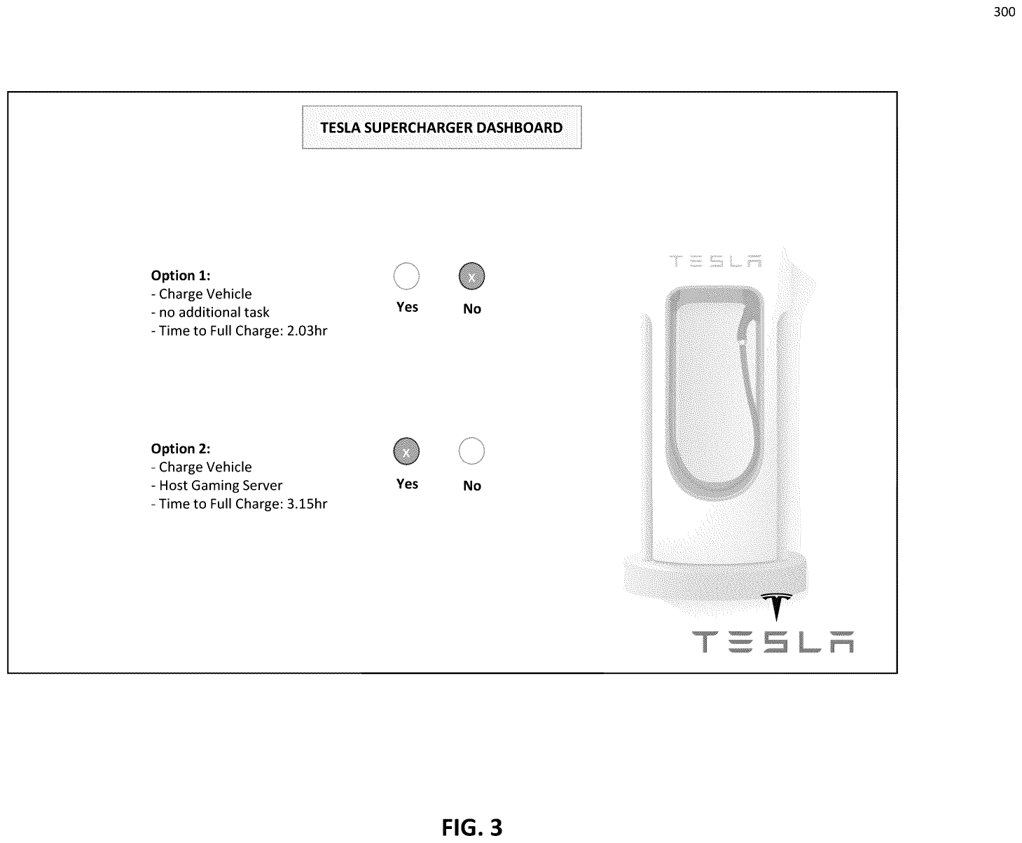

In some embodiments, the cloud service management server may generate for display a user-interface for a vehicle charging station. The user interface may include (a) a first option to charge, at a normal charging rate, a vehicle of the plurality of vehicles without performing the compute task, and (b) a second option to charge, at a reduced charging rate relative to the normal charging rate, the vehicle of the plurality of vehicles and performing the compute task. FIG. 3 shows an illustrative scenario 300 of a vehicle charger dashboard, in accordance with some embodiments of this disclosure. The dashboard has two options for selection with respect to the vehicle. Option 1 indicates that the vehicle will be charged with no additional task and the time to full charge is 2.03 hours. Alternatively, option 2 provides for the vehicle to be charged, but also to host a gaming server with the time to full charge extending to 3.15 hours. The cloud service management server may receive an input confirming selection of a second option from the vehicle. For example, confirmation receipt of input may be received at 104 in FIG. 1A. In some embodiments, the input may be received at any point after the vehicle is connected for charging. Continuing with the example in FIG. 2, option 2 is selected to charge the vehicle and host the gaming server. In some embodiments, the cloud service management server may determine the computing set of the plurality of vehicles is available to perform the compute task based on the receiving of the input from the vehicle confirming selection of the second option. For example, only if option 2 is selected, the vehicle would be included in the computing set. In some embodiments, the cloud service management server may access a selection history for each respective vehicle of the plurality of vehicles that includes historical option selection from the user-interface for the vehicle charging station. The cloud service management server may then determine whether the selection history for each respective vehicle of the plurality of vehicles exceeds a second option threshold. The second option threshold is a probability that the second option is more often selected than the first option. In some embodiments, the cloud service management server may receive instruction from the user-interface to schedule a compute task within the time for vehicle charging, set availability preferences, opt in or out of the service, and monitor the performance and earnings from their participation.

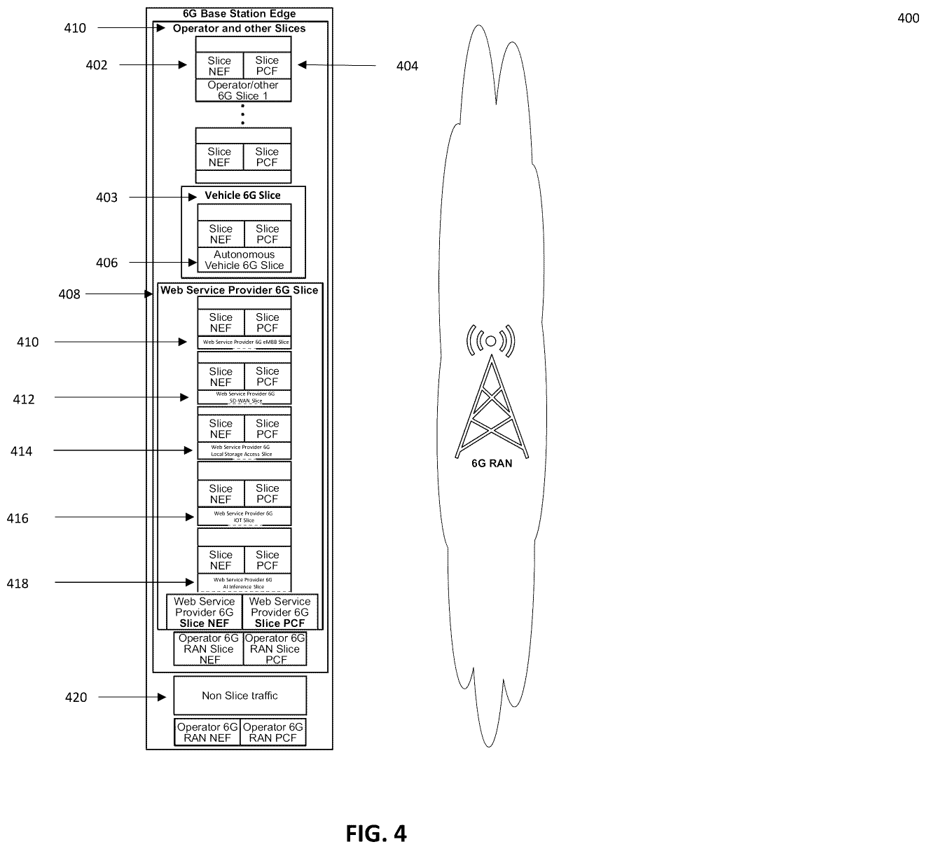

FIG. 4 shows an illustrative scenario 400 of a 6G network slice definition, in accordance with some embodiments of this disclosure. The 6G network may be implemented on communication network 1809 of FIG. 18. For example, the network slice may be called a recursive slice (e.g., the network slice can be suballocated for different sub-tasks). In this example, the 6G base station Edge is shown with both non-slice traffic 420 and operator 410 and other slices. The network operator could run their own slices and also create slices for business like autonomous vehicle companies and edge computing/service companies, cloud gaming companies, etc. Each slice has its own network exposure function (NEF) 402 and Policy Control Function (PCF) 404. A PCF may control network resource allocation based on predefined policies, subscriber data, and real-time conditions that may include managing Quality of Service (QOS), data usage, and other network policies. The PCF may ensure that network policies are consistently applied across all network slices and services, optimizing network performance and ensuring compliance with service level agreements (SLAs). The PCT may interact closely with other network functions like the access and mobility management function (AMF) and the session management function (SMF). A NEF allows external applications to access certain data from the cloud service management server. The NEF is a key component in the core network that exposes the capabilities and resources of the network to external applications and third-party services. The NEF acts as a secure gateway for external entities to access network services, providing mechanisms for authorization, traffic steering, and quality of service management. More specifically, the NEF may provide for access to analytics and performance data from the 6G slice. The NEF may also allow API calls to set parameters on traffic flows within that specific slice. The NEF plays a critical role in integrating various services with the network, ensuring that only authorized entities can access and modify network resources. It also collects and exposes network analytics, helping to optimize network performance and improve user experience. For example, in FIG. 1C, the cloud service management server may allocate a network slice (e.g., a Vehicle 6G Slice 403) to each vehicle to help facilitate minimal latency for hosting a gaming server (e.g., the compute task). This data can be used for a variety of services, such as location-based services, IoT applications, and more. Depending on the slice setup, the NEF and PCF along with certain APIs (e.g., NSAPI, network slicing API) will be exposed to the cloud service management server. A NSAPI is used for network slicing in networking, where a single physical network can be divided into multiple virtual networks (slices). Each slice can be customized for different types of services with specific requirements (e.g., low latency for autonomous vehicles or high bandwidth for video streaming). The NSAPI provides an interface for applications to interact with different network slices, allowing them to request, modify, and terminate network slices as needed. The NSAPI may ensure that the appropriate network resources are allocated based on the requirements of the application. These APIs may allow setting up inner slices, defining the bandwidth and latency and slice size. In FIG. 4, there is a specific 6G slice for Autonomous Vehicles 406 and a web services provider slice 408. Within the web services slice, there are enhanced mobile broadband (eMBB) inner slices. This will allow both the cloud service management server and the web service to access the internet within the larger Web Service 6G Slice. There is an inner slice for the Web Service Operator for SD-WAN connectivity at 412. This allows the communication in a protected private managed tunnel to the cloud service management server for orchestration and network optimization. There is an additional Slice for local storage access which is collocated with the base station at 414. This local storage may contain local database files and deployed VMs designed for specific hardware on specific autonomous vehicles. There is another specific slice which the services provider has defined for IOT devices at 416. This example also has a specific slice for AI inference at 418. There could be many more slices which could be defined by the web services/edge compute provider (e.g., shown for example in slice 410).

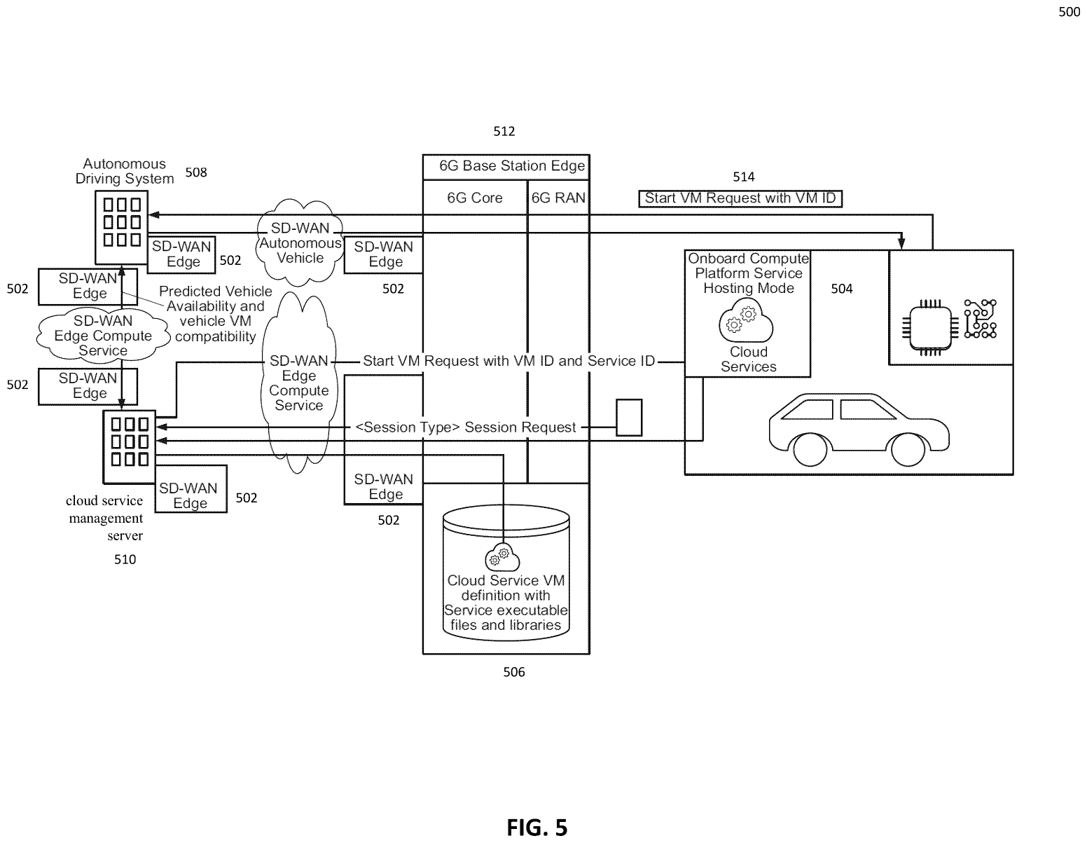

FIG. 5 shows an illustrative scenario 500 of a system diagram of a cloud service management server configured to a compute task from one or more vehicles, in accordance with some embodiments of this disclosure. In particular, this is an example of a dedicated software-defined wide area network (SD-WAN) specifically for the automobile edge compute partnership with an edge compute/web services provider (e.g. cloud service management server). In this case there is connectivity over the SDWAN, 502, between all 6G edge nodes for the mobile operator similar to the communication network in 1809 of FIG. 18. The SD-WAN contains edge nodes for connectivity from the autonomous driving system 508, the cloud service management server, and each base station. Traffic for the SD-WAN covering the edge compute task is over the SD-WAN. The interfaces for the vehicle reporting parameters, owner opt-in and vehicle historical data are transmitted from the vehicle's onboard compute platform service 504 for the vehicle to the cloud service management server. In some embodiments, a similar process may be seen in FIG. 1A where respective vehicle data (including historical data) is transferred from vehicle 1 and vehicle n, over the 6G network (e.g., which may implement SD-WAN), to the cloud service management server 104. The autonomous driving system (e.g., which may be 1807, 1808, or 1809 from FIG. 18) will make a determination if the vehicle is available for supporting edge computer indicator set to true. Analytics and forecasting as covered in the embodiments are also communicated over the SD-WAN interfaces. Once the onboard compute platform service 504 for vehicle will inform the cloud service management server is the vehicle is available for edge compute processing. The cloud service management server 510 determines the availability for edge compute along with virtual machine (VM) 506 compatibility. In these examples, the VM is the vehicle that is available to perform the compute task. If there is a need for a specific remote compute case and a platform is available at the mobile edge (e.g., 6G base station edge 512) that includes the requested cloud service and there is a compatible VM, a start request is sent to the vehicle with the VM ID and Service ID to start at 514. There is also an interface over the SD-WAN to the cloud system/edge compute provider to push VMs to the local storage at each of the mobile operator's edge sites. For example, in FIG. 1C, at 136 and 138, vehicle 1 and vehicle n process component x of the compute task, but this request to allocate these vehicle for the compute task is received via the 6G network 137. The 6G network 137 has local storage and thus, the cloud service management server may configure the compute from vehicle 1 and vehicle n to the local storage, 137, at each of the network's edge sites.

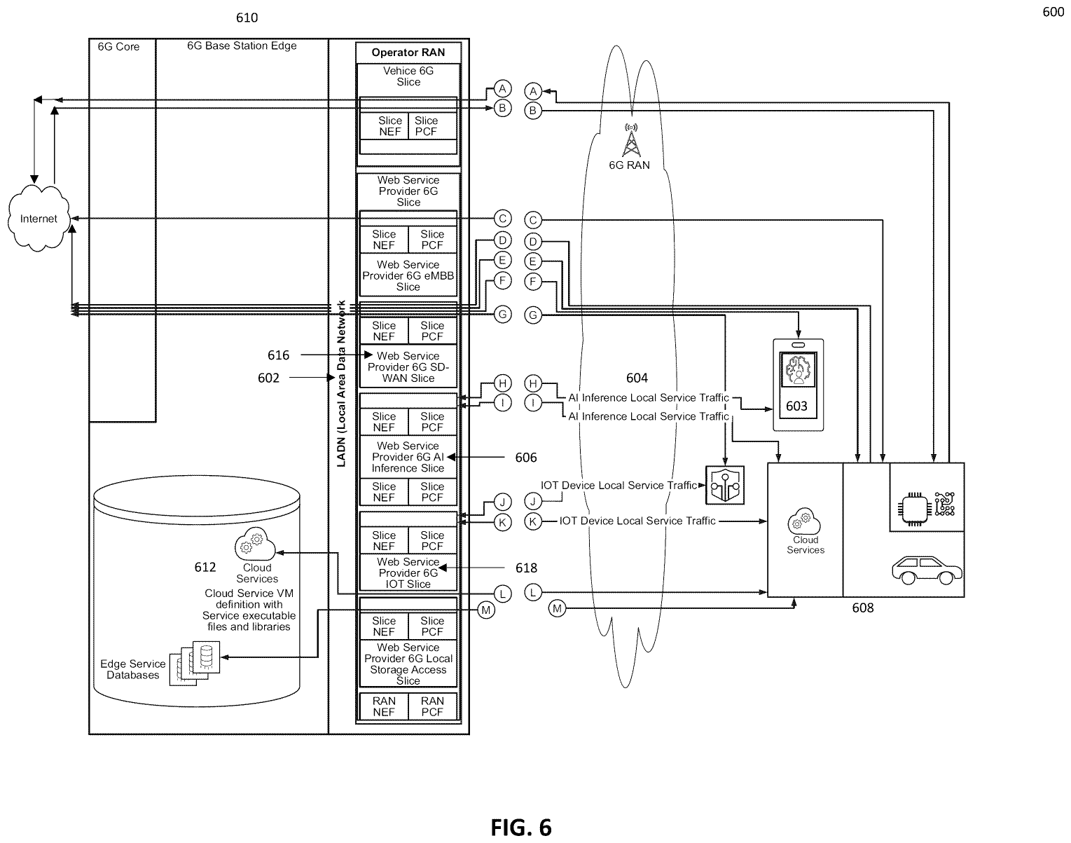

FIG. 6 shows an illustrative scenario 600 of a system diagram of cloud service management server with 6G network slice definition, in accordance with some embodiments of this disclosure. The 6G network may be implemented on communication network 1809 of FIG. 18. In particular, the diagram illustrates traffic across the various network slices and what traffic is always local to the base station 610. This shows two examples of an IOT device and an AI inference system on a mobile phone or tablet at 603. In this example, when a user starts the AI Inference App, an AI inference start request is made over the web service provider 6G SD-WAN dedicated inner slice to the Service Provider. The AI inference app may be a software module integrated into the cloud service management server. If there is a vehicle 608 connected to the base station 610 and available with a deployed VM with the service available, the cloud service provider 612 will make a request to the vehicle via cloud service management server to start the VM Request with the VM-ID and Service ID over the Web Services 6G SD-WAN Slice. For example, a similar scenario is outlined in FIG. 1A where there is a request made from a gaming server 102 to the cloud service management service for assistance in compute from vehicle 1 and vehicle n. The vehicle's compute via the cloud service management server will access and load the requested compatible VM for the service(s) requested over the web service provider's local storage access slice (e.g., as shown as 110 in FIG. 1A). Once the VM is running, the vehicle's cloud service management server will provide a response to the Service Provider's over the 6G SD-WAN dedicated inner slice which includes the IP connection into (address/port). The Cloud Service Provider 612 will provide the client device 603 an AI inference start session response with the connection information to connect over the base stations local area data network (LADN) 602 over the service provider's 6G SD-WAN dedicated inner slice 616. Client device will connect to the vehicle's AI inference service 604 over the dedicated web service provider's AI inference slice 606. All traffic between the vehicle's AI inference service and the client device running the AI Inference app will be over the dedicated web service provider's AI inference slice. Any data retrieval or storage needs from the AI inference service will be stored into the local data storage at the base station over the webservice provider 6G local access slice which is also over the LADN. As shown previously in FIG. 1C, there may be local storage for the base station at 137. Any Internet access needed by either the client device app or the AI inference service running on the vehicle will be over the web service provider's 6G eMBB slice. Additionally, there is an IOT device shown 603 and the initial setup is performed like the cast of the AI inference service however all LADN traffic for the IOT service is maintained within the web service provider's 6G IOT slice 618.

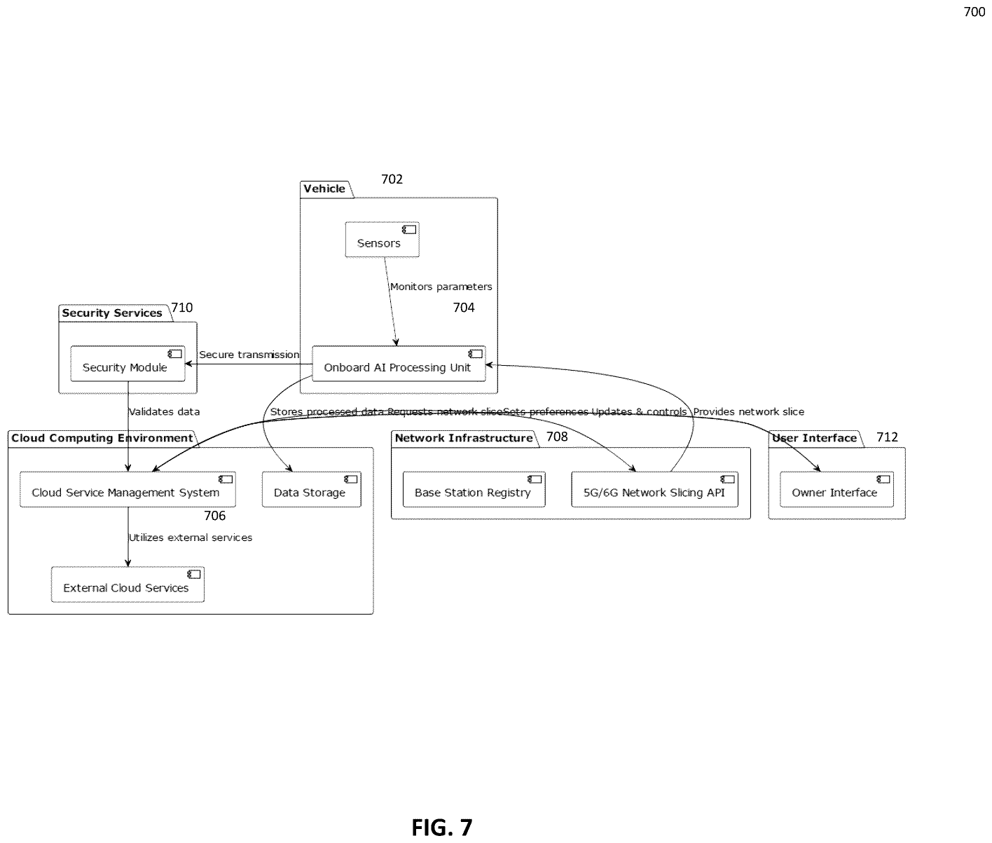

FIG. 7 shows an illustrative scenario 700 of a modular system diagram, in accordance with some embodiments of this disclosure. In an embodiment, the invention comprises a cloud service management server that comprises many modules including sensors and software integrated into a vehicle 702 to monitor parameters 704 crucial to determining when the vehicle's onboard computing processing unit can be safely utilized for cloud computing tasks. These parameters include the vehicle's current driving status, current or expected battery level (for example predicted battery level at arrival at a destination), internal and external temperature of the compute resource, charging status, and expected availability of high-speed network connectivity (5G, 6G, etc.) base stations at the destination via the network infrastructure 708. Data collected by these sensors is communicated to the cloud service management server 706, which uses this information to decide whether the computing processing unit is available for cloud computing without compromising the vehicle's primary functionalities. For example, this may be seen in FIG. 1 at 104, where the cloud service management server analyzes received vehicle data (e.g., including sensor data). Transmission of data may be transmitted via the 6G network through security services including a security module 710. In some embodiments, information regarding the determination of when the vehicle's onboard computing processing unit can be safely utilized for cloud computing tasks may be output to a user interface 712. For example, the user interface may be similar to the interface shown in FIG. 3.

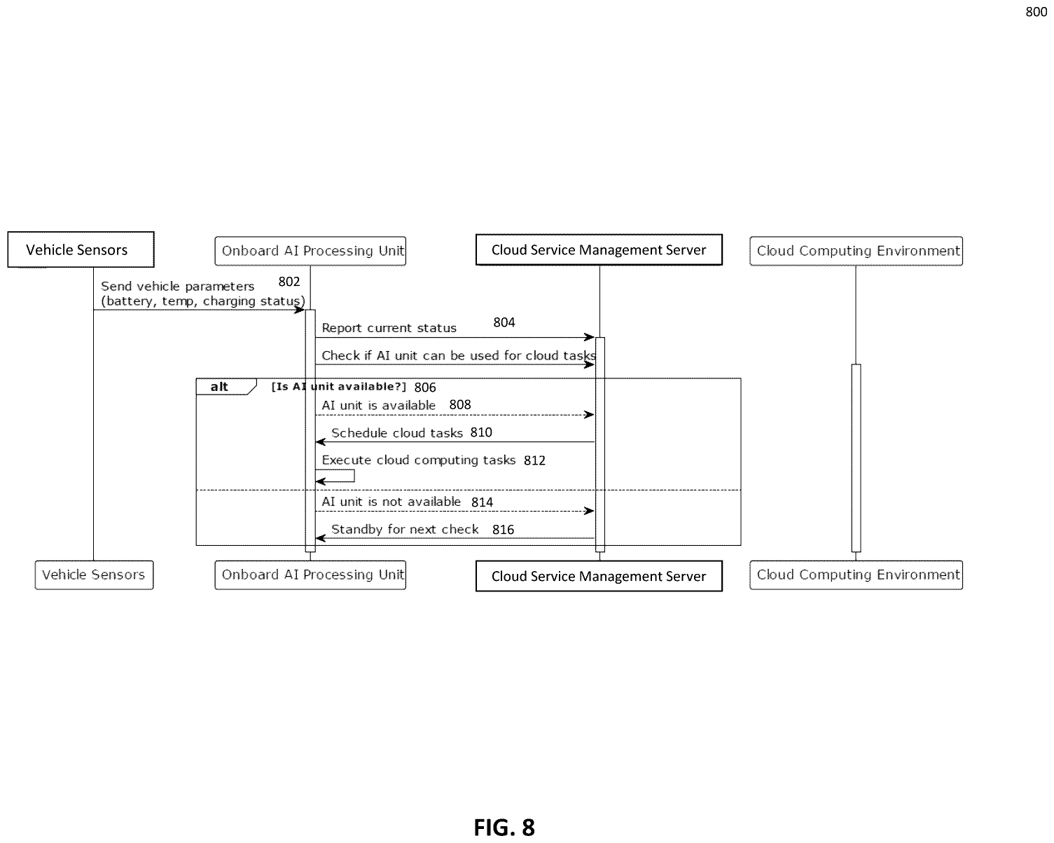

FIG. 8 shows an illustrative scenario 800 of a flow diagram for information passing from the vehicle sensors to the cloud service management server, in accordance with some embodiments of this disclosure. The onboard AI processing unit, a module of the cloud service management server, receives vehicle parameters 802 (e.g., battery, temperature, charging status) from the vehicle via vehicle sensors. The onboard AI processing unit, at 804, reports the current status to the cloud service management server. In some embodiments, the cloud service management server determines, at 806, whether an AI unit is available for processing. If the AI unit is available 808, the cloud service management server defers the scheduling of the compute task 810, execution of the compute task 812, and potentially other processing tasks to the AI unit. If the AI unit is not available 814, the cloud service management server schedules the compute task, executes the compute task, and is on standby 816 for other processing with inherent hardware as part of the cloud service management server.

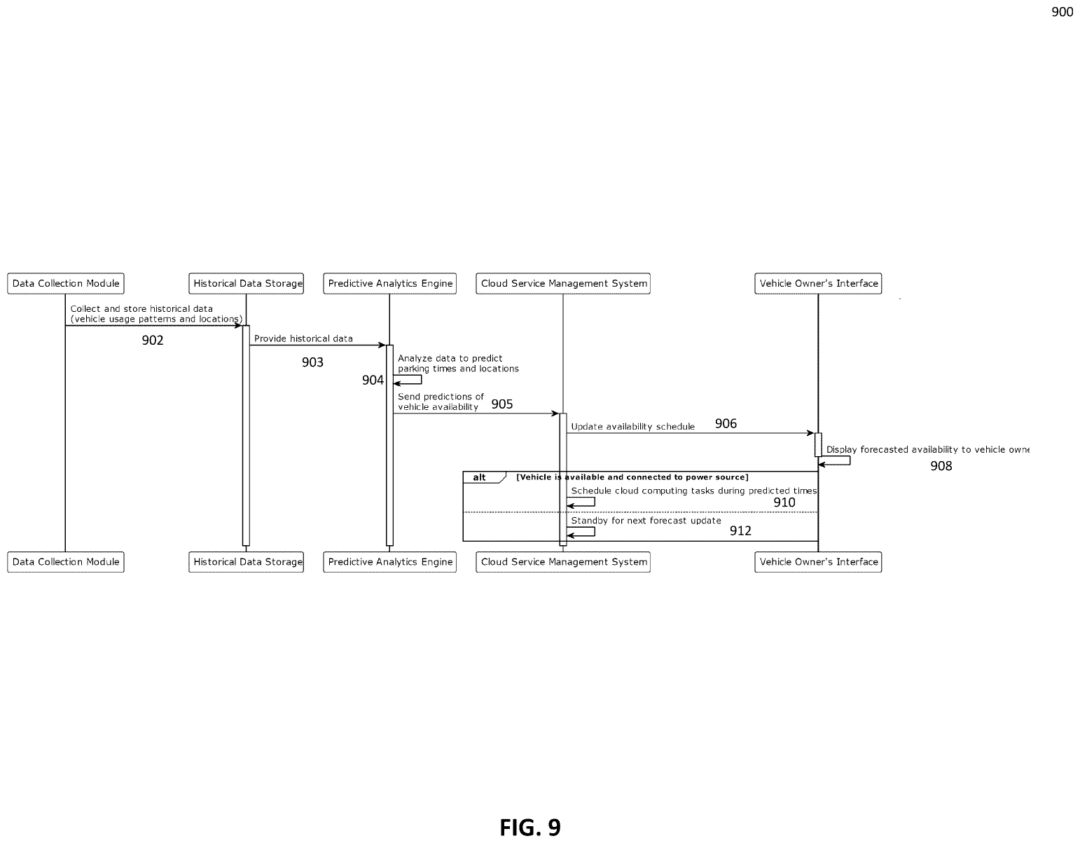

FIG. 9 shows an illustrative scenario of a flow diagram 900 including historical data storage of vehicles, in accordance with some embodiments of this disclosure. In this embodiment, the cloud service management server may predict the availability of the vehicle's computing processing unit based on its usage patterns and physical location. For example, a similar method may be seen in FIGS. 1A and 1B where the cloud service management server receives vehicle data 112, and compares historical data for vehicle 1 and vehicle n at 126. This method employs an analytical algorithm that analyzes historical data on the vehicle's typical parking times and locations. Such analysis enables the cloud service management server to forecast periods when the vehicle is likely to be parked and connected to a power source, making the computing processing unit available for cloud computing tasks during these times. For example, a vehicle may be stored at night and plugged in for charging. A historical data storage, at 902, receives data from a data collection module that includes data such as vehicle usage patterns and locations. A predictive analytics engine, which may be a module of the cloud service management server, receives the historical data 903, and at 904, analyzes the data to predict parking times and location and sends predictions of vehicle availability 905 to the cloud service management server. In some embodiments at 906, the cloud service management server may update the user-interface of the vehicle to display 908 the predicted availability to the user interface. For example, the user interface may be similar to the interface shown in FIG. 3. In some embodiments, the cloud service management server may automatically schedule compute tasks during predicted times 910 and be in standby mode for further updates 912.

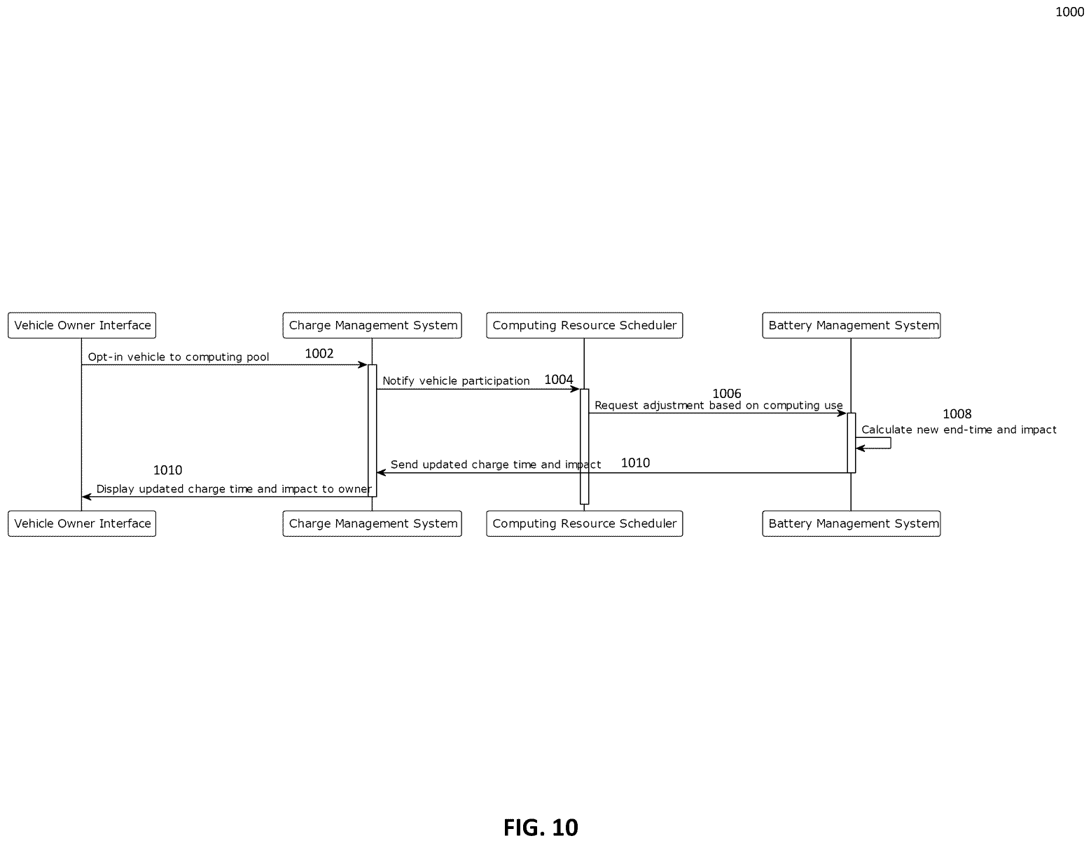

FIG. 10 shows an illustrative scenario of a flow diagram 1000 including a user interface of a vehicle, in accordance with some embodiments of this disclosure. For example, the user interface may be similar to the interface shown in FIG. 3, where Option 2 is selected where the vehicle has selected to opt in to hosting the game server and prolonging the charging period. In this embodiment, when a vehicle is opted into the computing set at 1002, the anticipated use of the computing resources is additionally considered when calculating the end-time of a charge at 1004. For example, if the cloud service management server receives a user-interface selection that the vehicle has opted into allowing their vehicle to be part of the computing set, and the vehicle is currently charging, the total charge time may be adjusted (via the request 1006 and calculation 1008) to reflect the usage in real time. Additionally, the cloud service management server could inform the vehicle's user-interface what the impact would be (in terms of electricity used or additional charging time) at 1010.

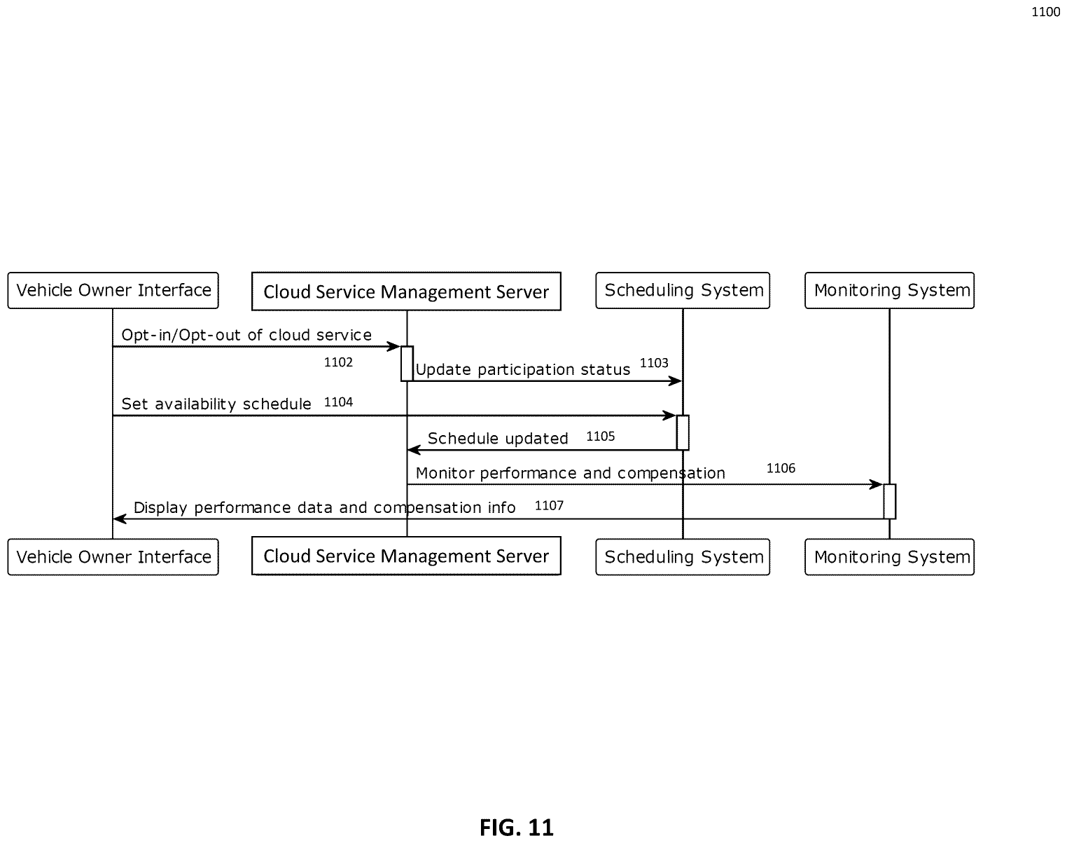

FIG. 11 shows an illustrative scenario of a flow diagram 1100 including a user interface providing options for opting in or out of a cloud service for a vehicle, in accordance with some embodiments of this disclosure. In this embodiment, the cloud service management server incorporates a user-interface for vehicle owners to manage the participation of their vehicle's computing compute for the compute task. This interface provides vehicle owners with control over setting availability schedules for their vehicle's compute, opting in or out of the compute task 1102, and monitoring the performance (via updating the participation status 1103) and compensation derived from lending their vehicle's computational power to the cloud service management server 1106. In some embodiments, the availability schedule is set 1104 and then updated 1105. The user-interface may enhance owner engagement and allows for customized participation in cloud computing tasks at 1107. As mentioned earlier, the user interface may be similar to the interface shown in FIG. 3, where Option 2 is selected where the vehicle has opted into hosting the gaming server and prolonging the charging period, and Option 1 is selected where the vehicle has opted out of hosting the gaming server.

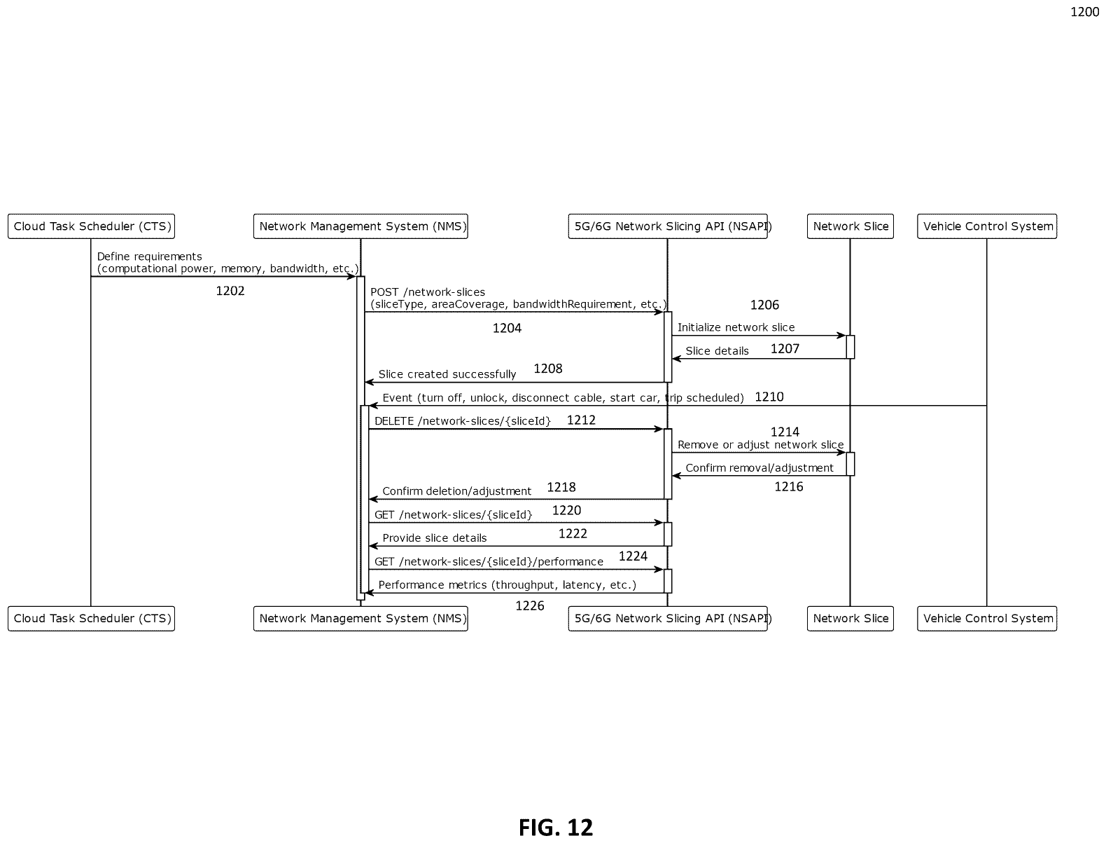

FIG. 12 shows an illustrative scenario of a flow diagram 1200 for a cloud task scheduler, in accordance with some embodiments of this disclosure. In this embodiment, the cloud service management server employs 5G or 6G network slicing technologies, leveraging network slicing application programming interfaces (APIs) to dynamically configure network parameters in alignment with the computational demands of cloud tasks assigned to the vehicle's computational processing unit. The system utilizes these APIs to determine and select the most suitable network slice 1208, considering the cloud tasks' computational needs and the vehicle's geographic location. This involves specifying the computational power, memory needs, and data bandwidth required by the cloud tasks. Depending on the sensitivity and nature of the data being processed, the cloud task may have specific security requirements. In some embodiments, the cloud task scheduler (CTS), a component of the cloud service management server, determines the requirements for network slices based on the cloud tasks assigned to the vehicle's computational processing unit at 1202. It details the necessary computational power, memory, data bandwidth, latency, and security protocols required for each task, ensuring the network resources are appropriately aligned with the needs of cloud operations. Working in tandem with the CTS, the network management system (NMS), also a module of the cloud service management server, plays a vital role in communicating with the network slicing API to manage the lifecycle of network slices at 1204. It handles tasks such as creating, updating, retrieving, and deleting network slices according to the specified requirements and continuously monitors their performance to ensure they meet the evolving demands of the cloud tasks.

In some embodiments, the 5G/6G network slicing API (NSAPI) interfaces directly with the network infrastructure to manage these network slices effectively at 1206. This API processes requests from the NMS to initiate, adjust, and provide updates about network slices and, when necessary, decommissions them to reallocate resources efficiently at 1207. The NSAPSI creates the network slice 1208. The network slice itself represents the actual segment of the network that is allocated and configured for specific computational tasks. It is dynamically managed to adapt to the changing requirements of the vehicle's cloud computing tasks, ensuring optimal performance and responsiveness to the needs of users and system demands. The following is an example API call to a 5G or 6G network slicing API.
Create Slice:
API Call: POST/network-slices
Parameters:
sliceType: Type of slice, e.g., eMBB, URLLC, mMTC
areaCoverage: Geographic coverage area
bandwidthRequirement: Minimum and maximum bandwidth
latencyRequirement: Desired latency
securityLevel: Security protocols needed
Purpose: Initializes the creation of a new network slice tailored to the specific requirements of an a task.
Update Slice:
API Call: PUT/network-slices/{sliceId}
Parameters:
sliceId: Unique identifier of the slice to be updated
bandwidthRequirement: Updated bandwidth needs
latencyRequirement: Updated latency targets
Purpose: Modifies an existing network slice to adapt to changes in the computing task's requirements or changes in network conditions.
Get Slice Information:
API Call: GET/network-slices/{sliceId}
Parameters:
sliceId: Unique identifier of the slice
Purpose: Retrieves the current configuration and status of a specific network slice.
Delete Slice:
API Call: DELETE/network-slices/{sliceId}
Parameters:
sliceId: Unique identifier of the slice to be deleted
Purpose: Removes a network slice when it is no longer required, freeing up resources for other uses.
Monitor Slice Performance:
API Call: GET/network-slices/{sliceId}/performance
Parameters:
sliceId: Unique identifier of the slice
Purpose: Provides performance metrics such as throughput, latency, packet loss, etc., to ensure the slice is meeting the task's needs

In some embodiments, in order to enable a hyperscaler to manage the 6G connectivity, the cloud service management server may use recursive slicing. This is initiated when the cloud service management server receives a request for network resources that specifies the required computational power, latency, bandwidth, and security parameters. Based on this request, the cloud service management server initiates an API call to configure a primary network slice that meets these broad requirements. An example API call to create a primary slice might look like this:

POST /network-slices
{
“sliceType”: “eMBB”,
“areaCoverage”: “geographic area of the vehicle”,
“bandwidthRequirement”: “500 Mbps”,
“latencyRequirement”: “10 ms”,
“securityLevel”: “high”
}

Once the primary slice is established, the cloud service management server can then dynamically create sub-slices as needed by the specific applications running on the vehicle. For instance, if a vehicle begins a task requiring enhanced security and lower latency, the cloud service management server might make another API call to create a sub-slice:

POST /network-slices/{parentSliceId}/sub-slices
{
“sliceType”: “URLLC”,
“bandwidthRequirement”: “100 Mbps”,
“latencyRequirement”: “1 ms”,
“securityLevel”: “very high”
}

Here, {parentSliceId} refers to the identifier of the primary slice under which this new sub-slice is created. This sub-slicing allows for granular control over network resources, enabling the cloud service management server to allocate precisely the amount of resources where and when they are needed. The cloud service management server monitors the status and performance of these slices and sub-slices in real-time, to adjust parameters or decommission slices as conditions change or as the vehicle moves across different network zones. In some embodiments, the NMS receives an event from the vehicle to decommission the network slice. For example, the event may be that the vehicle turns off, a vehicle door is unlocked, a charging cable is disconnected from the vehicle, the vehicle is initiated to engage driving mode, or a trip is scheduled and/or the trip is imminent at 1210. The NMS deletes the network slice 1212, and the NSPAI removes 1214 the network slice and confirms removal 1216. The NMS may then confirm the deletion/adjustment from NSAPI and transmits a GET function to NSAPI at 1220 and receives the slice details 1222. The NMS may then also transmit a GET function to NSAPI at 1224 for slice performance and receives the same 1226.

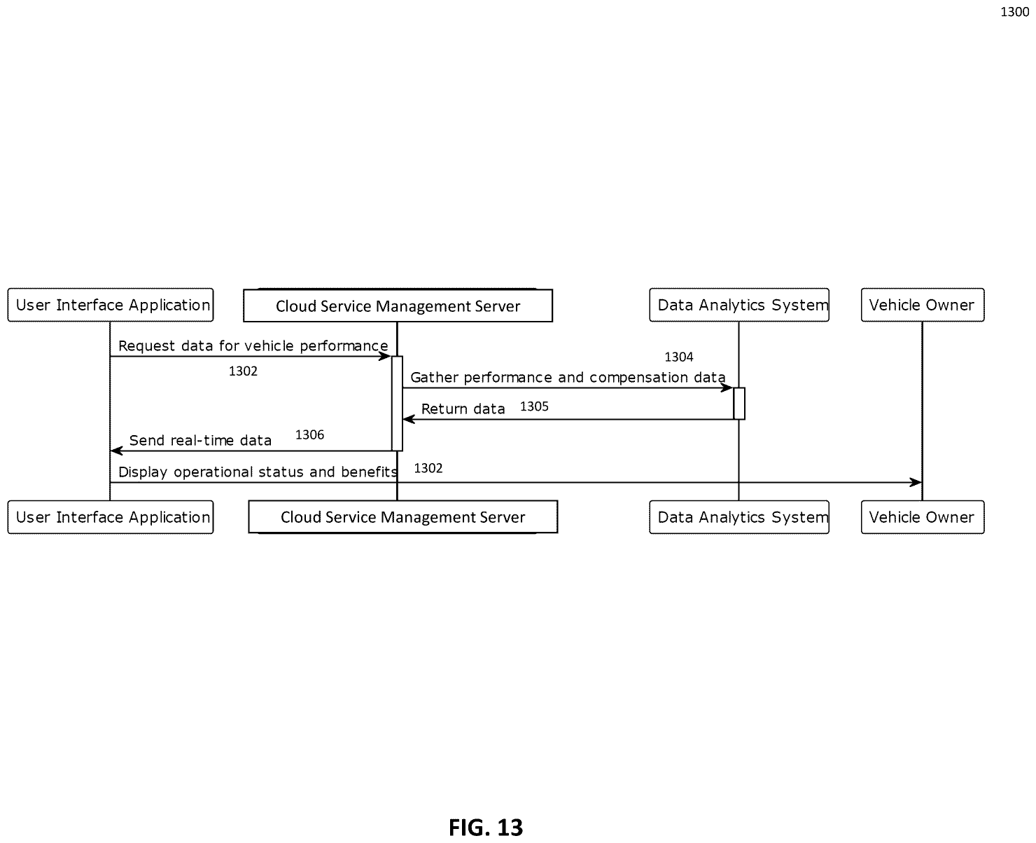

FIG. 13 shows an illustrative scenario of a flow diagram 1300 including a user interface receiving a request for vehicle performance data, in accordance with some embodiments of this disclosure. In an embodiment, the invention also features a feedback mechanism within the user interface application, providing vehicle owners with real-time data on the use and performance of their processing units at 1305. This feedback mechanism informs vehicle owners about the operational status of their units and the benefits, such as financial compensation, they are receiving from their participation in the cloud computing environment. The cloud service management server may receive a request for data of vehicle performance from the user-interface at 1302 and gathers the performance and compensation data from the data analytics system at 1304. The cloud service management server may then receive data at 1305 from the data analytics system (which in some embodiments may be a module of the cloud services management server) and sends the real-time data back to the user-interface at 1306. The user-interface application may then transmit the operational status and benefits to the vehicle owner. As mentioned earlier, the user interface may be similar to the interface shown in FIG. 3, where Option 2 is selected where the vehicle has opted into hosting the gaming server and prolonging the charging period and may also show benefits in terms of compensation (e.g., preferable monetary charging rate) or other benefits to the user.

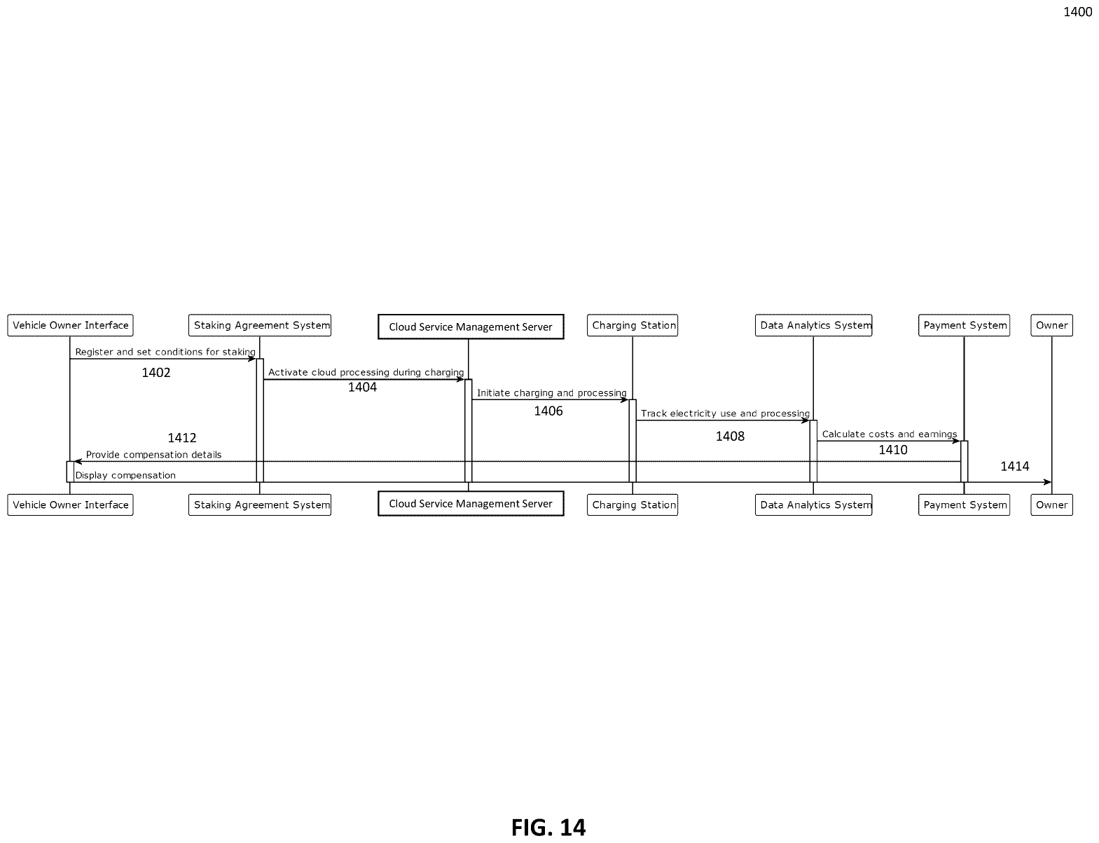

FIG. 14 shows an illustrative scenario of a flow diagram 1400 including a user interface that provides compensation details in relation to staking, in accordance with some embodiments of this disclosure. In an embodiment, the cloud service management server may provide for a feedback mechanism within the user-interface. The cloud service management server incorporates a reimbursement mechanism for vehicle owners when their vehicles are used for processing tasks during charging periods at paid parking spots at 1404 and 1406. This setup, referred herein as “staking the car,” involves the vehicle owner agreeing to keep the vehicle plugged into a charging station for a predetermined period, typically overnight, allowing it to be used for cloud computing tasks. The vehicle owner agrees to participate in a program where their car is staked for cloud processing while being charged at a specific location. This agreement is facilitated through a user interface application, where the owner may specify the duration and conditions under which the vehicle is available for cloud computing tasks at 1402. As mentioned earlier, the user interface may be similar to the interface shown in FIG. 3, where Option 2 is selected where the vehicle has opted into hosting the gaming server and may specify conditions for the duration and conditions for hosting the game server. The cloud service management server may track the usage of the vehicle's computing resources and the electricity consumed during this period 1408. A data analytics system, a component of the cloud service management server, may calculate the cost of charging and the earnings or credits gained from the cloud computing tasks at 1410. At the end of the staking period, the vehicle owner receives compensation which can offset the cost of charging or provide additional earnings at 1412. In some embodiments, the compensation is either reflected as a direct reimbursement for the electricity costs or as credits toward future charging sessions. The compensation may be generated for display via a user-interface 1414.

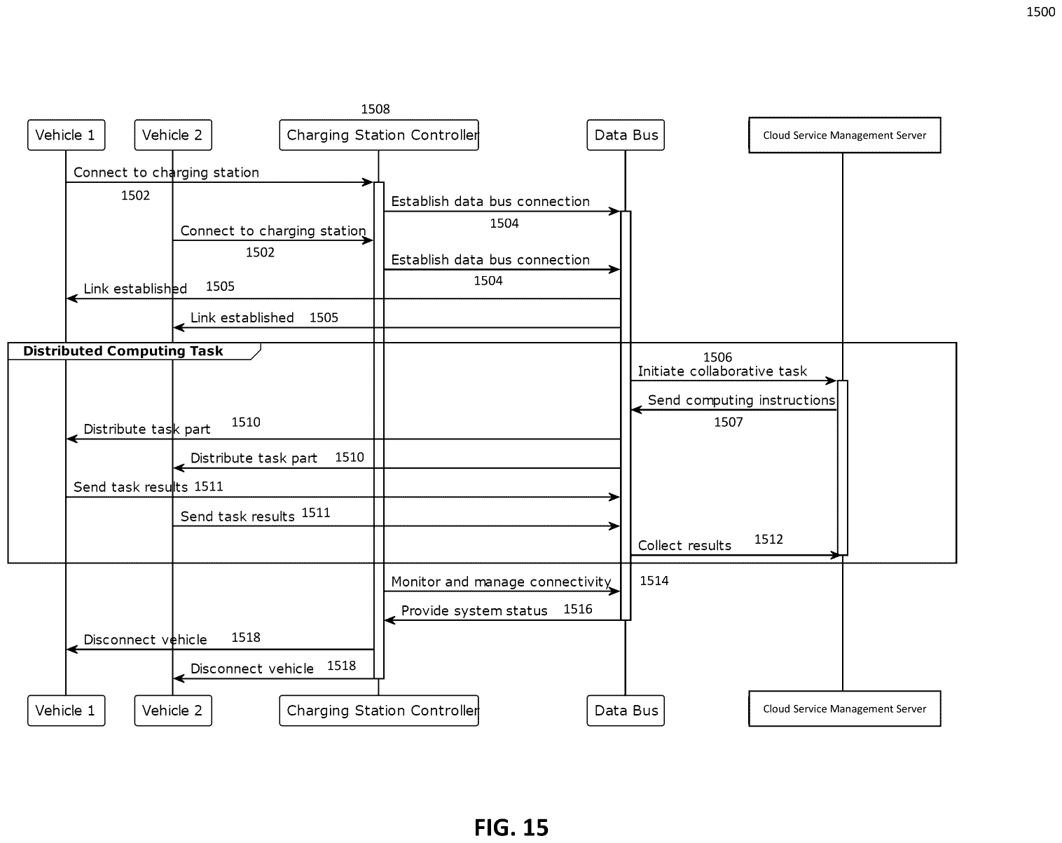

FIG. 15 shows an illustrative scenario of a flow diagram 1500 for a distributed computing task, in accordance with some embodiments of this disclosure. In an embodiment, the cloud service management server may expand the functionality of the vehicle staking system by incorporating a physical bus built into a charging station, enabling multiple vehicles to share a common connection for data and processing tasks. For example, FIG. 2 illustrates vehicle 1 (202) and vehicle n (204) are connected via a physical bus 206 such that respective hardware components of each vehicle are amalgamated into a singular hardware resource. This cloud service management server allows several vehicles, when connected via their charging cables 1502, to not only charge their batteries but also connect their onboard computing modules through a shared physical data bus 1504 and established the links between the vehicles 1505. This setup facilitates collaborative computing tasks or data sharing between the vehicles 1506 and the sending of instructions through the data bus 1507. This bus is capable of high-speed data transmission and supports multiple connections simultaneously. Once connected, the cloud service management server may configure the vehicles to participate in distributed or collaborative cloud computing tasks. This could include combined data processing tasks 1510 where computational load is shared across several vehicles, enhancing processing efficiency and reducing task completion times. The cloud service management server may dynamically configure and manage the connections and data flows between the vehicles based on predefined rules or real-time decisions. This management is handled by a central controller 1508, a component of the cloud service management server, within the charging station that monitors connectivity, provides high-speed connectivity, allocates bandwidth, and monitors system integrity. The results are collected by the cloud service management server 1512 from vehicles 1 and 2 (1511). The cloud service management server, via the charging station controller, continues to monitor and manage the connectivity 1514 and provide system status 1516 which is all facilitates through the physical data bus. At some point later, the vehicles are disconnected from the physical charging station 1518.

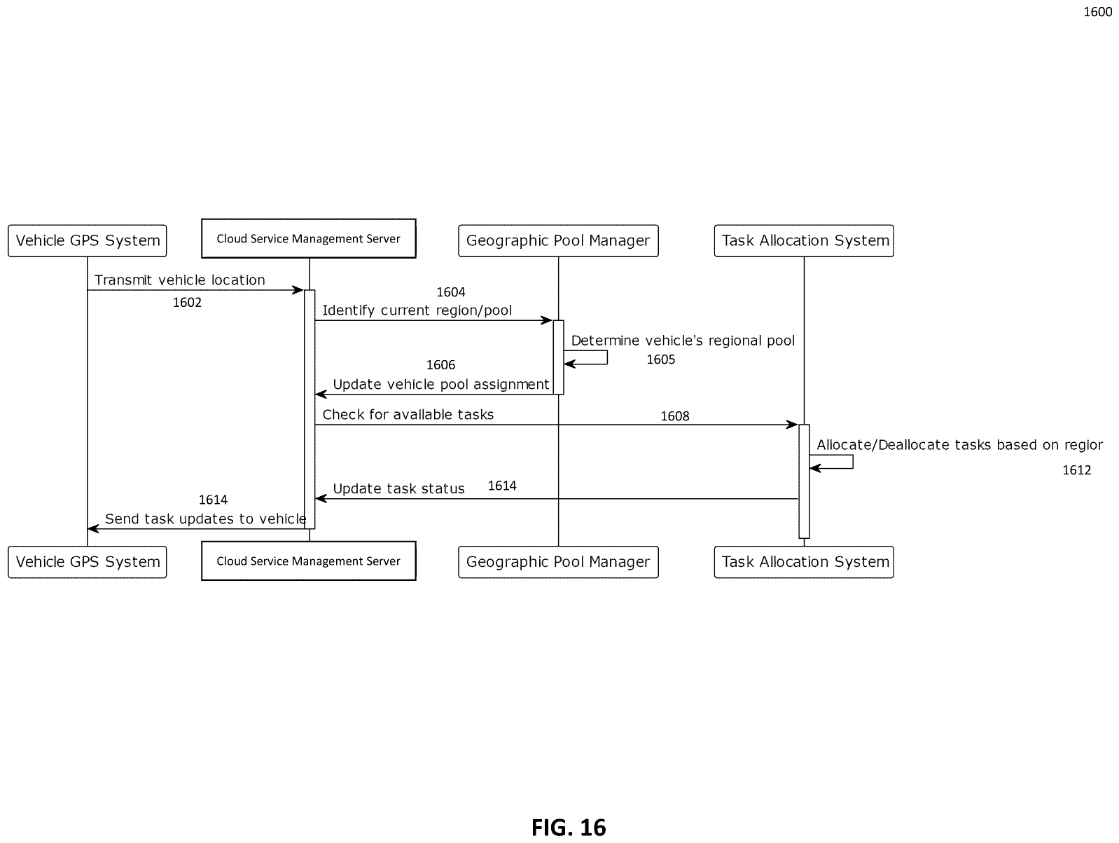

FIG. 16 shows an illustrative scenario of a flow diagram 1600 for vehicle GPS system transmitting vehicle location data, in accordance with some embodiments of this disclosure. In an embodiment, the cloud service management server may dynamically add available vehicles to hyperlocalized computing sets. These hyper-local regions, identified as either regions or sub-regions within the cloud service management server interface, may facilitate the organization and deployment of vehicle-based computational resources based on geographic location. An example of location data may be seen at paragraph 0039 specifically at the table entitled History of Availability Data for Vehicle n. The cloud service management services receives the vehicle's location via GPS data at 1602. The cloud service management server may identify vehicles based on their current geographic locations and dynamically assigns them to corresponding local pools within the cloud computing management system at 1604. These pools are defined by specific geographic boundaries, which can be as granular as neighborhoods within a city or areas along specific transportation routes. As such, the cloud service management server may identify a vehicle's regional pool at 1605. As vehicles move and enter or exit these defined geographic regions, the cloud service management server may automatically update the pool membership 1606. This ensures that the allocation of computational resources is continually optimized for geographic relevance and efficiency. The cloud service management server may monitor the location and availability of each vehicle in real time at 1608. The cloud service management server may use this information to dynamically allocate and deallocate computing tasks 1612 to vehicles as they move from one region to another. This capability is supported by real-time data communication between the vehicles and the cloud service management server, which may adjust to changes in vehicle status and location without manual intervention (e.g., updating task status at 1614). Each vehicle communicates its status and location to the cloud service management server using secure, highspeed data transmission protocols. This allows the cloud service management server to maintain an up-to-date view of resource availability and ensures that computational tasks can be managed effectively across the hyperlocalized pools. The cloud service management server may employ algorithms to balance the computational load across different regions and pools. This maintains system performance and efficiency, especially during peak times when certain regions may experience higher demand for computational resources. As these computer resources become available, the cloud service management server may allocate or de-allocate these resources based on the location and region.

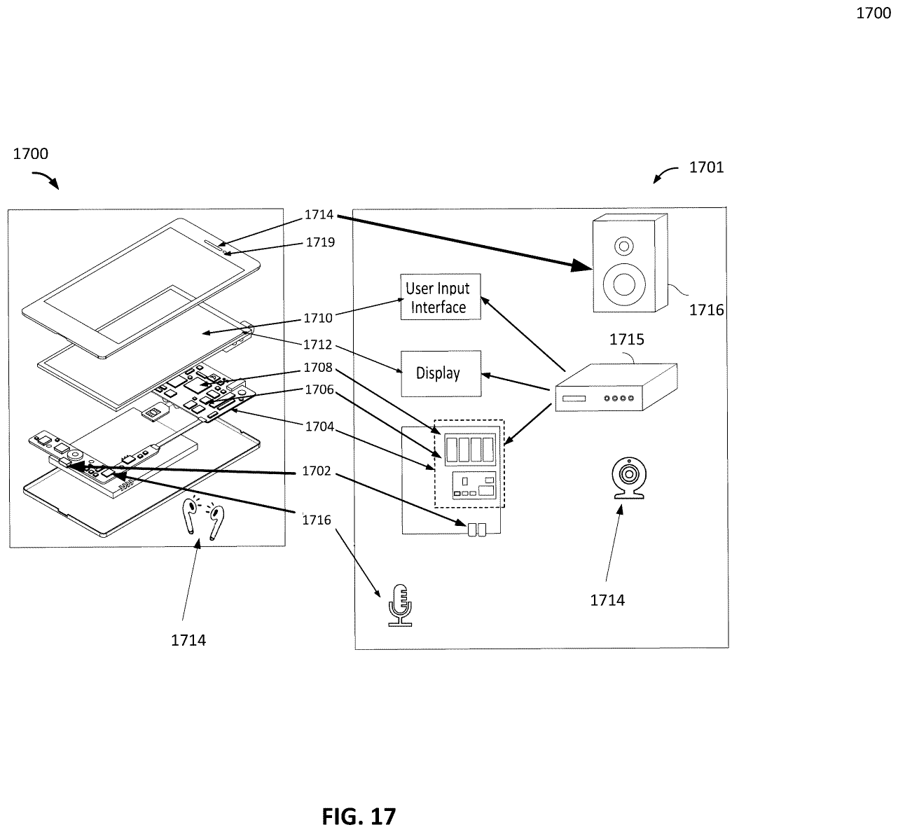

FIGS. 17-18 describe illustrative devices, systems, servers, and related hardware for a media application for processing and executing spoiler prevention for non-linear media. FIG. 17 shows generalized embodiments of illustrative user devices 1700 and 1701. For example, user equipment device 1700 may be a smartphone device, a tablet, smart glasses, a virtual reality or augmented reality device (e.g., AR goggles, AR headset, AR implemented via smartphone, tablet, or computer), or any other suitable device capable of consuming media assets and capable of transmitting and receiving data over a communication network. In another example, user equipment device 1701 may be a user television equipment system or device. In another example, the user equipment device 1701 may be a vehicle equipped with processing and network communication means. This vehicle may be an autonomous vehicle or a non-autonomous vehicle. User television equipment device 1701 may include set-top box 1715. Set-top box 1715 may be communicatively connected to microphone 1716, audio output equipment (e.g., speaker or headphones 1714), and display 1712. In some embodiments, microphone 1716 may receive audio corresponding to a voice of a user, e.g., a voice command. In some embodiments, display 1712 may be a television display or a computer display. In some embodiments, set-top box 1715 may be communicatively connected to user input interface 1710. In some embodiments, user input interface 1710 may be a remote-control device. Set-top box 1715 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment devices are discussed below in connection with FIG. 17. In some embodiments, device 1700 may comprise any suitable number of sensors, as well as a GPS module (e.g., in communication with one or more servers and/or cell towers and/or satellites) to ascertain a location of device 1700.

Each one of user equipment device 1700 and user equipment device 1701 may receive content and data via input/output (I/O) path 1702. I/O path 1702 may provide content (e.g., broadcast programming, on-demand programming, Internet content, content available over a local area network (LAN) or wide area network (WAN), and/or other content) and data to control circuitry 1704, which may comprise processing circuitry 1706 and storage 1708. Control circuitry 1704 may be used to send and receive commands, requests, and other suitable data using I/O path 1702, which may comprise I/O circuitry. I/O path 1702 may connect control circuitry 1704 (and specifically processing circuitry 1706) to one or more communications paths (described below). I/O functions may be provided by one or more of these communications paths but are shown as a single path in FIG. 17 to avoid overcomplicating the drawing. While set-top box 1715 is shown in FIG. 17 for illustration, any suitable computing device having processing circuitry, control circuitry, and storage may be used in accordance with the present disclosure. For example, set-top box 1715 may be replaced by, or complemented by, a personal computer (e.g., a notebook, a laptop, a desktop), a smartphone (e.g., device 1700), a tablet, a network-based server hosting a user-accessible client device, a non-user-owned device, any other suitable device, or any combination thereof.

Control circuitry 1704 may be based on any suitable control circuitry such as processing circuitry 1706. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1704 executes instructions for the Media application stored in memory (e.g., storage 1708). Specifically, control circuitry 1704 may be instructed by the Media application to perform the functions discussed above and below. In some implementations, processing or actions performed by control circuitry 1704 may be based on instructions received from the Media application.

In client/server-based embodiments, control circuitry 1704 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 18, the instructions may be stored in storage 1708, and executed by control circuitry 1704 of a device 1700.

In some embodiments, the media application may be a client/server application where only the client application resides on device 1700, and a server application resides on an external server (e.g., server 1804). For example, the media application may be implemented partially as a client application on control circuitry 1704 of device 1700 and partially on server 1804 as a server application running on control circuitry 1811. Server 1804 may be a part of a local area network with one or more of devices 1700 or may be part of a cloud computing environment accessed via the internet. In a cloud computing environment, various types of computing services for performing searches on the internet or informational databases, providing storage (e.g., for a database) or parsing data are provided by a collection of network-accessible computing and storage resources (e.g., server 1804), referred to as “the cloud.” Device 1700 may be a cloud client that relies on the cloud computing capabilities from server 1804 to determine whether processing should be offloaded and facilitate such offloading. When executed by control circuitry 1704 or 1811, the media application may instruct control circuitry 1704 or 1811 circuitry to perform processing tasks for the client device and facilitate a media consumption session integrated with social network services. The client application may instruct control circuitry 1704 to determine whether processing should be offloaded.

Control circuitry 1704 may include communications circuitry suitable for communicating with a server, social network service, a table or database server, or other networks or servers The instructions for carrying out the above-mentioned functionality may be stored on a server (which is described in more detail in connection with FIG. 18). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 18). In addition, communications circuitry may include circuitry that enables peer-to-peer communication of user equipment devices, or communication of user equipment devices in locations remote from each other (described in more detail below).

Memory may be an electronic storage device provided as storage 1708 that is part of control circuitry 1704. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1708 may be used to store various types of content described herein as well as media application data described above. Nonvolatile memory may also be used (e.g., to launch a boot-up routine and other instructions). Cloud-based storage may be used to supplement storage 1708 or instead of storage 1708.

Control circuitry 1704 may include video generating circuitry and adjustment circuitry, such as one or more analog tuners, one or more MPEG-2 decoders or other digital decoding circuitry, high-definition tuners, or any other suitable adjustment or video circuits or combinations of such circuits. Encoding circuitry (e.g., for converting over-the-air, analog, or digital signals to MPEG signals for storage) may also be provided. Control circuitry 1704 may also include scaler circuitry for upconverting and downconverting content into the preferred output format of user equipment 1700. Control circuitry 1704 may also include digital-to-analog converter circuitry and analog-to-digital converter circuitry for converting between digital and analog signals. The adjustment and encoding circuitry may be used by user equipment device 1700, 1701 to receive and to display, to play, or to record content. The adjustment and encoding circuitry may also be used to receive media consumption data. The circuitry described herein, including for example, the adjustment, video generating, encoding, decoding, encrypting, decrypting, scaler, and analog/digital circuitry, may be implemented using software running on one or more general purpose or specialized processors. Multiple tuners may be provided to handle simultaneous adjustment functions (e.g., watch and record functions, picture-in-picture (PIP) functions, multiple-tuner recording, etc.). If storage 1708 is provided as a separate device from user equipment device 1700, the adjustment and encoding circuitry (including multiple tuners) may be associated with storage 1708.

Control circuitry 1704 may receive instruction from a user by way of user input interface 1710. User input interface 1710 may be any suitable user interface, such as a remote control, mouse, trackball, keypad, keyboard, touch screen, touchpad, stylus input, joystick, voice recognition interface, or other user input interfaces. Display 1712 may be provided as a stand-alone device or integrated with other elements of each one of user equipment device 1700 and user equipment device 1701. For example, display 1712 may be a touchscreen or touch-sensitive display. In such circumstances, user input interface 1710 may be integrated with or combined with display 1712. In some embodiments, user input interface 1710 includes a remote-control device having one or more microphones, buttons, keypads, or any other components configured to receive user input or combinations thereof. For example, user input interface 1710 may include a handheld remote-control device having an alphanumeric keypad and option buttons. In a further example, user input interface 1710 may include a handheld remote-control device having a microphone and control circuitry configured to receive and identify voice commands and transmit information to set-top box 1715.

Audio output equipment 1714 may be integrated with or combined with display 1712. Display 1712 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 1712. Audio output equipment 1714 may be provided as integrated with other elements of each one of device 1700 and equipment 1701 or may be stand-alone units. An audio component of videos and other content displayed on display 1712 may be played through speakers (or headphones) of audio output equipment 1714. In some embodiments, audio may be distributed to a receiver (not shown), which processes and outputs the audio via speakers of audio output equipment 1714. In some embodiments, for example, control circuitry 1704 is configured to provide audio cues to a user, or other audio feedback to a user, using speakers of audio output equipment 1714. There may be a separate microphone 1716 or audio output equipment 1714 may include a microphone configured to receive audio input such as voice commands or speech. For example, a user may speak letters or words that are received by the microphone and converted to text by control circuitry 1704. In a further example, a user may voice commands that are received by a microphone and recognized by control circuitry 1704. Camera 1718 may be any suitable video camera integrated with the equipment or externally connected. Camera 1718 may be a digital camera comprising a charge-coupled device (CCD) and/or a complementary metal-oxide semiconductor (CMOS) image sensor. Camera 1718 may be an analog camera that converts to digital images via a video card.

The media application may be implemented using any suitable architecture. For example, it may be a stand-alone application wholly implemented on each one of user equipment device 1700 and user equipment device 1701. In such an approach, instructions of the application may be stored locally (e.g., in storage 1708), and data for use by the application is downloaded on a periodic basis (e.g., from an out-of-band feed, from an Internet resource, or using another suitable approach). Control circuitry 1704 may retrieve instructions of the application from storage 1708 and process the instructions to provide media consumption and social network interaction functionality and generate any of the displays discussed herein. Based on the processed instructions, control circuitry 1704 may determine what action to perform when input is received from user input interface 1710. For example, movement of a cursor on a display up/down may be indicated by the processed instructions when user input interface 1710 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 1704 may allow a user to provide user profile information or may automatically compile user profile information. For example, control circuitry 1704 may access and monitor network data, video data, audio data, processing data, participation data from a media application and social network profile. Control circuitry 1704 may obtain all or part of other user profiles that are related to a particular user (e.g., via social media networks), and/or obtain information about the user from other sources that control circuitry 1704 may access. As a result, a user can be provided with a unified experience across the user's different devices.

In some embodiments, the media application is a client/server-based application. Data for use by a thick or thin client implemented on each one of user equipment device 1700 and user equipment device 1701 may be retrieved on-demand by issuing requests to a server remote to each one of user equipment device 1700 and user equipment device 1701. For example, the remote server may store the instructions for the application in a storage device. The remote server may process the stored instructions using circuitry (e.g., control circuitry 1704) and generate the displays discussed above and below. The client device may receive the displays generated by the remote server and may display the content of the displays locally on device 1700. This way, the processing of the instructions is performed remotely by the server while the resulting displays (e.g., that may include text, a keyboard, or other visuals) are provided locally on device 1700. Device 1700 may receive inputs from the user via input interface 1710 and transmit those inputs to the remote server for processing and generating the corresponding displays. For example, device 1700 may transmit a communication to the remote server indicating that an up/down button was selected via input interface 1710. The remote server may process instructions in accordance with that input and generate a display of the application corresponding to the input (e.g., a display that moves a cursor up/down). The generated display may then be transmitted to device 1700 for presentation to the user.

In some embodiments, the media application may be downloaded and interpreted or otherwise run by an interpreter or virtual machine (run by control circuitry 1704). In some embodiments, the media application may be encoded in the ETV Binary Interchange Format (EBIF), received by control circuitry 1704 as part of a suitable feed, and interpreted by a user agent running on control circuitry 1704. For example, the media application may be an EBIF application. In some embodiments, the media application may be defined by a series of JAVA-based files that are received and run by a local virtual machine or other suitable middleware executed by control circuitry 1704. In some of such embodiments (e.g., those employing MPEG-2 or other digital media encoding schemes), the media application may be, for example, encoded and transmitted in an MPEG-2 object carousel with the MPEG audio and video packets of a program.

FIG. 18 is a diagram of an illustrative system 1800, in accordance with some embodiments of this disclosure. User equipment devices 1807, 1808, 1809, 1810 (e.g., user device; devices or any other suitable devices, vehicles, or any combination thereof) may be coupled to communication network 1806. Communication network 1806 may be one or more networks including the Internet, a mobile phone network, mobile voice or data network (e.g., a 5G, 4G, or LTE network, or any other suitable network or any combination thereof), cable network, public switched telephone network, or other types of communication network or combinations of communication networks. Paths (e.g., depicted as arrows connecting the respective devices to the communication network 1806) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 8 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 602-11x, etc.), or other short-range communication via wired or wireless paths. The user equipment devices may also communicate with each other directly through an indirect path via communication network 1806.

System 1800 may comprise media content source 1802, one or more servers 1804, and one or more social network services. In some embodiments, the media application may be executed at one or more of control circuitry 1811 of server 1804 (and/or control circuitry of user equipment devices 1807, 1808, 1809, 1810.

In some embodiments, server 1804 may include control circuitry 1811 and storage 1814 (e.g., RAM, ROM, Hard Disk, Removable Disk, etc.). Instructions for the media application may be stored in storage 1814. In some embodiments, the media application, via control circuitry, may execute functions outlined in FIGS. 1-16. Storage 1814 may store one or more databases. Server 1804 may also include an input/output path 1812. I/O path 1812 may provide media consumption data, social networking data, device information, or other data, over a local area network (LAN) or wide area network (WAN), and/or other content and data to control circuitry 1811, which may include processing circuitry, and storage 1814. Control circuitry 1811 may be used to send and receive commands, requests, and other suitable data using I/O path 1812, which may comprise I/O circuitry. I/O path 1812 may connect control circuitry 1811 (and specifically control circuitry) to one or more communications paths. I/O path 1812 may comprise I/O circuitry.

Control circuitry 1811 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1811 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1811 executes instructions for an emulation system application stored in memory (e.g., the storage 1814). Memory may be an electronic storage device provided as storage 1814 that is part of control circuitry 1811.

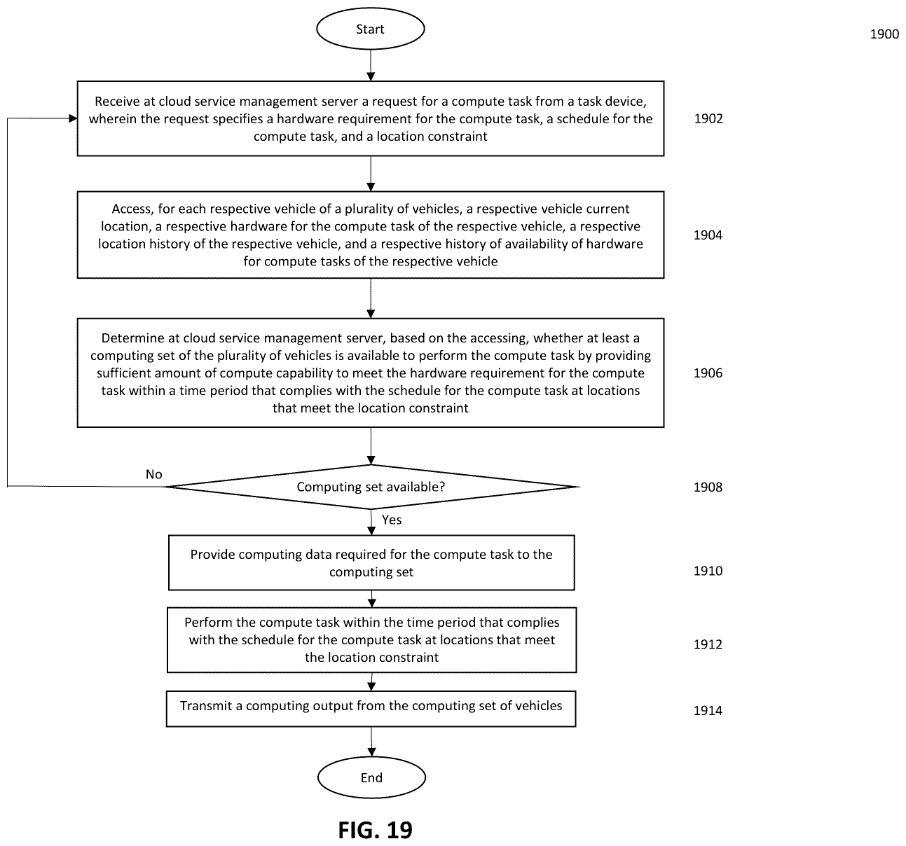

FIG. 19 is a flowchart of a detailed illustrative process for determining whether a computing set of a plurality of vehicles is available to perform a compute task, in accordance with some embodiments of this disclosure. In various embodiments, the individual steps of process 1900 may be implemented by one or more components of the devices and systems of FIGS. 1-18. Although the present disclosure may describe certain steps of process 1900 (and of other processes described herein) as being implemented by certain components of the devices and systems of FIGS. 1-17, this is for purposes of illustration only, and it should be understood that other components of the devices and systems of FIGS. 1-18 may implement those steps instead.

At 1902, the cloud service management server, via the control circuitry 1811, receives a request for a compute task from a task device. The request specifies a hardware requirement for the compute task, a schedule for the compute task, and a location constraint. As stated earlier, control circuitry 711 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, the cloud service management server may receive the request via the communication network 1809 (e.g., which may be a configured on a 6G protocol), via the I/O path 1812 from user equipment 1707, 1708, 1710.

At 1904, the cloud service management server, via the control circuitry 1811, accesses for each respective vehicle of a plurality of vehicles, a respective vehicle current location, a respective hardware for the compute task of the respective vehicle, a respective location history of the respective vehicle, and a respective history of availability of hardware for compute tasks of the respective vehicle. In some embodiments, the cloud service management server may perform the accessing via the communication network 1809 (e.g., which may be a configured on a 6G protocol), via the I/O path 1812 from user equipment 1707, 1708, 1710. In some embodiments, the accessing may be from, server 1804, database 1805, or storage 1814.

At 1906, the cloud service management server, via the control circuitry 1811, determines at cloud service management server, based on the accessing, whether at least a computing set of the plurality of vehicles is available to perform the compute task by providing sufficient amount of compute capability to meet the hardware requirement for the compute task within a time period that complies with the schedule for the compute task at locations that meet the location constraint. If, at 1908, the cloud service management server, via control circuitry 1811, determines the computing set of the plurality of vehicles is not available to perform the compute task, the process reverts to 1902. If, at 1908, the cloud service management server, via control circuitry 1811, determines the computing set of the plurality of vehicles is available to perform the compute task, the process continues to 1910.

At 1910, the cloud service management server, via the control circuitry 1811, provides computing data required for the compute task to the computing set. In some embodiments, the provision may be performed via the communication network 1809 (e.g., which may be configured on a 6G protocol), and/or via the I/O path 1812.

At 1912, the cloud service management server, via the control circuitry 1811, causes the performance of the compute task within the time period that complies with the schedule for the compute task at locations that meet the location constraint. In some embodiments, the performance may be performed via the communication network 1809 (e.g., which may be configured on a 6G protocol), and/or via the I/O path 1812.

At 1914, the cloud service management server, via the control circuitry 1811, transmits a computing output from the computing set of vehicles. In some embodiments, the transmission may be performed via the communication network 1809 (e.g., which may be configured on a 6G protocol), and/or via the I/O path 1812 to user equipment 1707, 1708, 1710.

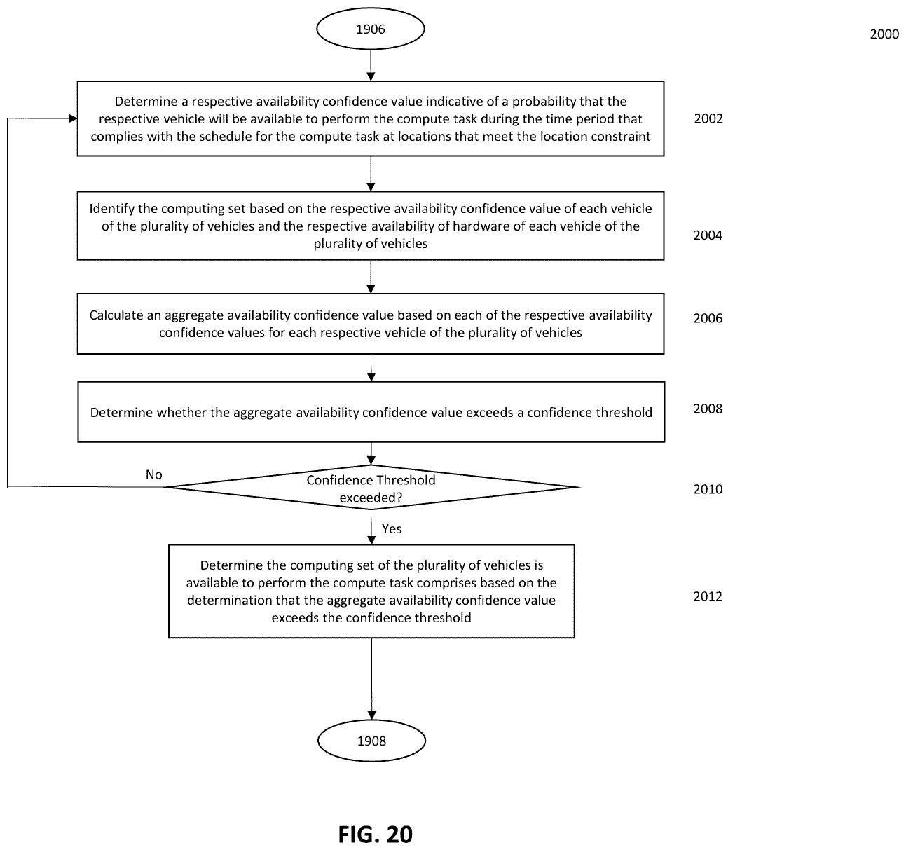

FIG. 20 is a flowchart of a detailed illustrative process 2000 for determining a respective availability confidence value indicative of a probability that the respective vehicle will be available to perform the compute task, in accordance with some embodiments of this disclosure. At 2002, the cloud service management server, via the control circuitry 1811, determines a respective availability confidence value indicative of a probability that the respective vehicle will be available to perform the compute task during the time period that complies with the schedule for the compute task at locations that meet the location constraint.

At 2004, the cloud service management server, via the control circuitry 1811, identifies the computing set based on the respective availability confidence value of each vehicle of the plurality of vehicles and the respective availability of hardware of each vehicle of the plurality of vehicles.

At 2006, the cloud service management server, via the control circuitry 1811, calculates an aggregate availability confidence value based on each of the respective availability confidence values for each respective vehicle of the plurality of vehicles.

At 2008, the cloud service management server, via the control circuitry 1811, determines whether the aggregate availability confidence value exceeds a confidence threshold. If, at 2010, the cloud service management server, via control circuitry 1811, determines the aggregate availability confidence value does not exceed the confidence threshold, the process reverts to 2002. If, at 2010, the cloud service management server, via control circuitry 1811, determines the aggregate availability confidence value exceeds the confidence threshold, the process continues to 2012.

At 2012, the cloud service management server, via the control circuitry 1811, determines the computing set of the plurality of vehicles is available to perform the compute task comprises based on the determination that the aggregate availability confidence value exceeds the confidence threshold.

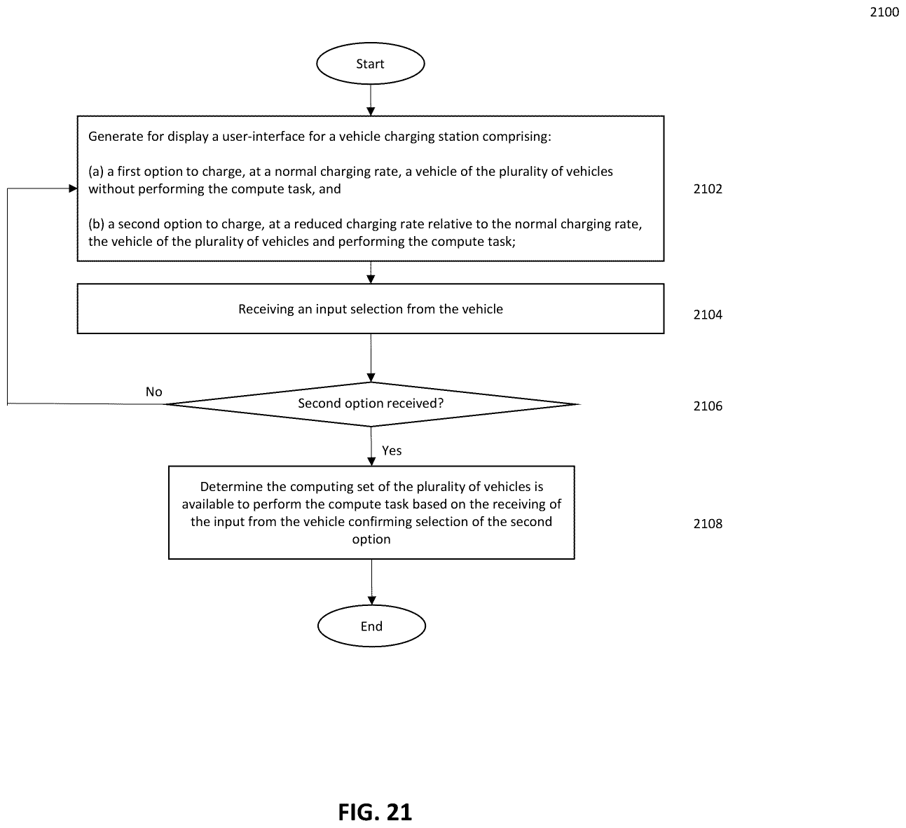

FIG. 21 is a flowchart of a detailed illustrative process 2100 for generating for display a user-interface for a vehicle charging station, in accordance with some embodiments of this disclosure. At 2102, the cloud service management server, via the control circuitry 1811, generates for display a user-interface for a vehicle charging station comprising (a) a first option to charge, at a normal charging rate, a vehicle of the plurality of vehicles without performing the compute task, and (b) a second option to charge, at a reduced charging rate relative to the normal charging rate, the vehicle of the plurality of vehicles and performing the compute task. In some embodiments, the cloud service management server generates the user-interface via the communication network 1809 (e.g., which may be configured on a 6G protocol), via the I/O path 1812 from user equipment 1707, 1708, 1710. In some embodiments, the cloud service management server may retrieve data used for the user-interface from, server 1804, database 1805, or storage 1814.

At 2104, the cloud service management server, via the control circuitry 1811, receives an input selection from the vehicle. In some embodiments, the cloud service management server receives the input confirming selection via the communication network 1809 (e.g., which may be configured on a 6G protocol), via the I/O path 1812 from user equipment 1707, 1708, 1710. If, at 2106, the cloud service management server, via control circuitry 1811, the input selection from the vehicle does not confirm selection of the second option, the process reverts to 2102. If, the input selection from the vehicle confirms selection of the second option, the process continues to 2108.

At 2108, the cloud service management server, via the control circuitry 1811, determines the computing set of the plurality of vehicles is available to perform the compute task based on the receiving of the input from the vehicle confirming selection of the second option.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving at cloud service management server a request for a compute task from a task device, wherein the request specifies a hardware requirement for the compute task, a schedule for the compute task, and a location constraint;
accessing, for each respective vehicle of a plurality of vehicles, a respective vehicle current location, a respective hardware for the compute task of the respective vehicle, a respective location history of the respective vehicle, and a respective history of availability of hardware for compute tasks of the respective vehicle;
determining at cloud service management server, based on the accessing, whether at least a computing set of the plurality of vehicles is available to perform the compute task by providing sufficient amount of compute capability to meet the hardware requirement for the compute task within a time period that complies with the schedule for the compute task at locations that meet the location constraint;
in response to a determination that the computing set is available to perform the compute task:
providing computing data required for the compute task to the computing set, wherein the providing causes the computing set of vehicles to:
perform the compute task within the time period that complies with the schedule for the compute task at locations that meet the location constraint; and
transmit a computing output from the computing set.

2. The method of claim 1, wherein the determining whether the computing set of the plurality of vehicles is available to perform the compute task comprises:
for each respective vehicle of the plurality of vehicles:
determining a respective availability confidence value indicative of a probability that the respective vehicle will be available to perform the compute task during the time period that complies with the schedule for the compute task at locations that meet the location constraint; and
identifying the computing set based on the respective availability confidence value of each vehicle of the plurality of vehicles and the respective availability of hardware of each vehicle of the plurality of vehicles.

3. The method of claim 2, further comprising:
calculating an aggregate availability confidence value based on each of the respective availability confidence values for each respective vehicle of the plurality of vehicles;
determining whether the aggregate availability confidence value exceeds a confidence threshold; and
wherein the determining whether the computing set of the plurality of vehicles is available to perform the compute task comprises:
determining the computing set of the plurality of vehicles is available to perform the compute task comprises based on the determination that the aggregate availability confidence value exceeds the confidence threshold.

4. The method of claim 2, wherein the hardware requirement comprises at least one of: a requirement for a particular type of central processing unit, a requirement for a particular type of graphical processing unit, a requirement for a particular type of an artificial-intelligence chipset, a requirement for a particular type of dedicated chipset for a defined task function, a requirement for a particular type of memory, a requirement for a particular type of cache, a requirements for a particular type of storage, or a requirement for a particular type of processing chips.

5. The method of claim 1, wherein the compute task is performed using a network operating on a 6G protocol; and
wherein the method further comprises:
determining a network classification of the compute task based on an assigned classification; and
allocating at least one network slice for the computing set of the plurality of vehicles from a plurality of network slices in a common network, wherein the allocated network slice is optimized for the network classification.

6. The method of claim 5, further comprising:
suballocating a portion of the at least one allocated network slice for each respective vehicle of the computing set of the plurality of vehicles, wherein the suballocating provides for exclusive network resource for each respective vehicle of the computing set of the plurality of vehicles.

7. The method of claim 1, wherein:
at least two vehicles of the plurality of vehicles are connected via a physical bus such that respective hardware components of each of the at least two vehicles are amalgamated into a singular hardware resource;
and wherein the singular hardware resource performs the compute task at a higher performance than the at least two vehicles without the physical bus; and
wherein the determining whether the computing set of the plurality of vehicles is available to perform the compute task comprises accessing data for availability of the singular hardware resource that performs the compute task at the higher performance than the at least two vehicles without the physical bus.

8. The method of claim 7, further comprising:
based on the accessing of the respective location histories of the at least two vehicles of the plurality of vehicles connected via the physical bus, determining a bus confidence value that the at least two vehicles will be connected via the physical bus;
determining whether the bus confidence value exceeds a bus confidence threshold;
and wherein the determining whether the computing set of the plurality of vehicles is available to perform the compute task comprises:
determining the computing set of the plurality of vehicles is available to perform the compute task comprises based on the determination that the bus confidence value exceeds the bus confidence threshold.

9. The method of claim 1, further comprising:
generating for display a user-interface for a vehicle charging station comprising (a) a first option to charge, at a normal charging rate, a vehicle of the plurality of vehicles without performing the compute task, and (b) a second option to charge, at a reduced charging rate relative to the normal charging rate, the vehicle of the plurality of vehicles and performing the compute task;
receiving an input confirming selection of second option from the vehicle; and
wherein the determining whether the computing set of the plurality of vehicles is available to perform the compute task comprises:
determining the computing set of the plurality of vehicles is available to perform the compute task based on the receiving of the input from the vehicle confirming selection of the second option.

10. The method of claim 9, further comprising:
accessing a selection history for each respective vehicle of the plurality of vehicles, wherein the selection history comprises historical option selection from the user-interface for the vehicle charging station;
and wherein the determining whether the computing set of the plurality of vehicles is available to perform the compute task comprises:
determining whether the selection history for each respective vehicle of the plurality of vehicles exceeds a second option threshold, wherein the second option threshold comprises a probability than the second option is more often selected than the first option.

11. The method of claim 1, wherein the request further specifies a software requirement, and wherein:
determining whether the at least the computing set of the plurality of vehicles is available to perform the compute task comprises determining whether the computing set of the plurality of vehicles comprises at least one vehicle with installed software that complies with the software requirement.

12. A system comprising:
control circuitry configured to:
receive at cloud service management server a request for a compute task from a task device, wherein the request specifies a hardware requirement for the compute task, a schedule for the compute task, and a location constraint;
access, for each respective vehicle of a plurality of vehicles, a respective vehicle current location, a respective hardware for the compute task of the respective vehicle, a respective location history of the respective vehicle, and a respective history of availability of hardware for compute tasks of the respective vehicle;
determine at cloud service management server, based on the accessing, whether at least a computing set of the plurality of vehicles is available to perform the compute task by providing sufficient amount of compute capability to meet the hardware requirement for the compute task within a time period that complies with the schedule for the compute task at locations that meet the location constraint;
in response to a determination that the computing set is available to perform the compute task:
provide computing data required for the compute task to the computing set, wherein the providing causes the computing set of vehicles to:
perform the compute task within the time period that complies with the schedule for the compute task at locations that meet the location constraint; and
transmit a computing output from the computing set.

13. The system of claim 12, wherein the control circuitry is configured, when determining whether the computing set of the plurality of vehicles is available to perform the compute task, to:
for each respective vehicle of the plurality of vehicles:
determine a respective availability confidence value indicative of a probability that the respective vehicle will be available to perform the compute task during the time period that complies with the schedule for the compute task at locations that meet the location constraint; and
identify the computing set based on the respective availability confidence value of each vehicle of the plurality of vehicles and the respective availability of hardware of each vehicle of the plurality of vehicles.

14. The system of claim 13, wherein the control circuitry is further configured to:
calculate an aggregate availability confidence value based on each of the respective availability confidence values for each respective vehicle of the plurality of vehicles;
determine whether the aggregate availability confidence value exceeds a confidence threshold; and
wherein the determining whether the computing set of the plurality of vehicles is available to perform the compute task comprises:
determine the computing set of the plurality of vehicles is available to perform the compute task comprises based on the determination that the aggregate availability confidence value exceeds the confidence threshold.

15. The system of claim 13, wherein the hardware requirement comprises at least one of: a requirement for a particular type of central processing unit, a requirement for a particular type of graphical processing unit, a requirement for a particular type of an artificial-intelligence chipset, a requirement for a particular type of dedicated chipset for a defined task function, a requirement for a particular type of memory, a requirement for a particular type of cache, a requirements for a particular type of storage, or a requirement for a particular type of processing chips.

16. The system of claim 12, wherein the compute task is performed using a network operating on a 6G protocol; and
wherein the system is further configured to:
determine a network classification of the compute task based on an assigned classification; and
allocate at least one network slice for the computing set of the plurality of vehicles from a plurality of network slices in a common network, wherein the allocated network slice is optimized for the network classification.

17. The system of claim 16, wherein the system is further configured to:
suballocate a portion of the at least one allocated network slice for each respective vehicle of the computing set of the plurality of vehicles, wherein the suballocating provides for exclusive network resource for each respective vehicle of the computing set of the plurality of vehicles.

18. The system of claim 12, wherein:
at least two vehicles of the plurality of vehicles are connected via a physical bus such that respective hardware components of each of the at least two vehicles are amalgamated into a singular hardware resource;
and wherein the singular hardware resource performs the compute task at a higher performance than the at least two vehicles without the physical bus; and
wherein the system is configured to determine whether the computing set of the plurality of vehicles is available to perform the compute task comprises accessing data for availability of the singular hardware resource that performs the compute task at the higher performance than the at least two vehicles without the physical bus.

19. The system of claim 18, wherein the system is further configured to:
based on the accessing of the respective location histories of the at least two vehicles of the plurality of vehicles connected via the physical bus, determine a bus confidence value that the at least two vehicles will be connected via the physical bus;
determine whether the bus confidence value exceeds a bus confidence threshold;
and wherein the system is configured, when determining whether the computing set of the plurality of vehicles is available to perform the compute task, to:
determine the computing set of the plurality of vehicles is available to perform the compute task comprises based on the determination that the bus confidence value exceeds the bus confidence threshold.

20. The system of claim 12, wherein the system is further configured to:
generate for display a user-interface for a vehicle charging station comprising (a) a first option to charge, at a normal charging rate, a vehicle of the plurality of vehicles without performing the compute task, and (b) a second option to charge, at a reduced charging rate relative to the normal charging rate, the vehicle of the plurality of vehicles and performing the compute task;
receive an input confirming selection of second option from the vehicle; and
and wherein the system is configured, when determining whether the computing set of the plurality of vehicles is available to perform the compute task, to:
determine the computing set of the plurality of vehicles is available to perform the compute task based on the receiving of the input from the vehicle confirming selection of the second option.

21-55. (canceled)
